(19) United States
(12) Patent Application Publication
(10) Pub. No.: US 2015/0269243 A1
(43) Pub. Date: Sep. 24, 2015

(54) COMPUTER PRODUCT, SOFTWARE DIVIDING APPARATUS, AND SOFTWARE DIVIDING METHOD

(71) Applicant: FUJITSU LIMITED, Kawasaki-shi (JP)

(72) Inventor: Kenichi KOBAYASHI, Kawasaki (JP)

(73) Assignee: Fujitsu Limited, Kawasaki (JP)

(21) Appl. No.: 14/631,433

(22) Filed: Feb. 25, 2015

(30) Foreign Application Priority Data
Mar. 19, 2014 (JP) 2014-057116

(51) Int. Cl. G06F 17/30

(52) U.S. Cl. CPC G06F 17/30598

(57) ABSTRACT

A non-transitory, computer-readable recording medium stores a program that causes a computer to execute a process that includes dividing a target entity set into clusters, the target entity set being divided according to a selection of the target entity set to be processed among an entity group as a constituent element group of software, the target entity set being divided based on a weight that is related to a dependence relationship between entities of the entity group and identified by the dependence relationship, the target entity set being divided so that a total of the weights related to the dependence relationships between the entities within a same cluster will be higher than an expected value of the total; and selecting, when a count of entities within a cluster among the divided clusters exceeds a pre-stored upper-limit number of entities, an entity set within the cluster as the target entity set.

### CROSS REFERENCE TO RELATED APPLICATIONS

This application is based upon and claims the benefit of priority of the prior Japanese Patent Application No. 2014-057116, filed on Mar. 19, 2014, the entire contents of which are incorporated herein by reference.

### FIELD

The embodiments discussed herein are related to a software dividing program, a software dividing apparatus, and a software dividing method.

### BACKGROUND

Understanding of software is important for development, improvement, and maintenance of the software. Software of a large scale becomes complicated in its structure and is not easy to recognize. If complicated software can be divided into small-scale, manageable units, the software can be understood intuitively and easily. For this reason, the software has to be divided into subsets of such a small scale as to enable easy understanding.

With respect to relevant known technological documents, there is a technology of dividing an entity group constituting software into plural clusters, based on a weight related to a dependence relationship to be identified by correspondence information correlating an entity as a source of the relationship and an entity as a destination of the relationship. There is a technology that uses a modularity evaluation function as a measure of good clustering of a graph to search for a clustering for which the modularity evaluation function comes to a maximum, by a greedy algorithm.

Although this is not a technology related to software division, there is a technology of letting a user set the maximum number of clusters at the uppermost layer and sorting an accumulated knowledge group into knowledge clusters, based on such setting. There is a technology of classifying images to be classified into clusters so that the total number of clusters will be a specified value and at the same time, the number of images belonging to each cluster will become equal to or smaller than the upper-limit number of images. For examples of such technologies, refer to Japanese Laid-Open Patent Publication Nos. 2013-148987; 2003-044485; and 2012-048641 as well as M. E. J. Newman (2004) “Fast algorithm for detecting community structure in networks”, Physical Review, E69(6):066133.

Nonetheless, with the conventional technologies, when the scale of software becomes large, it is difficult to divide the software into the manageable units. For example, in the case of software in which the number of source files is more than 2000, the number of subsets of the source files into which the software is divided can exceed 50 and even if the software is divided, the understanding of the software by a human can be difficult.

### SUMMARY

According to an aspect of an embodiment, a non-transitory, computer-readable recording medium stores therein a software dividing program that causes a computer to execute a process that includes dividing a target entity set into plural clusters, the target entity set being divided according to a selection of the target entity set to be processed among an entity group as a constituent element group of software, the target entity set being divided based on a weight that is related to a dependence relationship between entities of the entity group and identified by the dependence relationship, the target entity set being divided so that a total of the weights related to the dependence relationships between the entities within a same cluster will be higher than an expected value of the total; and selecting, when a count of entities within a cluster among the divided plural clusters exceeds a pre-stored upper-limit number of entities, an entity set within the cluster as the target entity set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a software dividing method according to a first embodiment;

FIG. 2 is an explanatory diagram of one example of a graph structure of a cluster that cannot be improved;

FIG. 3 is a block diagram depicting an example of a hardware configuration of a software dividing apparatus 100;

FIG. 4 is a block diagram depicting an example of a functional configuration of the software dividing apparatus 100 according to the first embodiment;

FIG. 5 is an explanatory diagram of a specific example of cluster granularity reference information 420;

FIG. 6 is an explanatory diagram of a graphic representation example of software SW;

FIG. 7 is an explanatory diagram of a source code example of the software SW;

FIG. 8 is an explanatory diagram of a specific example of relationship graph information 430;

FIG. 9 is an explanatory diagram of one example of a process of clustering;

FIG. 10 is an explanatory diagram of a specific example of division results before integration;

FIG. 11 is an explanatory diagram (part 1) of a hierarchical structure example of the software SW;

FIG. 12 is an explanatory diagram (part 2) of a hierarchical structure example of the software SW;

FIG. 13 is an explanatory diagram of a specific example of the division results after the integration;

FIG. 14 is a flowchart of one example of a software dividing procedure of the software dividing apparatus 100 according to the first embodiment;

FIG. 15 is a flowchart of one example of a specific procedure of relationship extraction processing;

FIG. 16 is a flowchart of one example of a specific procedure of weight calculation processing;

FIG. 17 is a flowchart of one example of a specific procedure of clustering processing;

FIG. 18 is a flowchart of one example of a specific procedure of weighted, directed modularity maximization processing;

FIG. 19 is a flowchart of one example of a specific procedure of integration processing;

FIG. 20 is an explanatory diagram of an example of the software dividing method according to a second embodiment;

FIG. 21 is an explanatory diagram of an example of multi-layer division;

FIG. 22 is a block diagram of a functional configuration example of the software dividing apparatus 100 according to the second embodiment;

FIG. 23 is an explanatory diagram of a specific example of relationship graph information R regarding a cluster set to be processed;

FIG. 24 is an explanatory diagram of a graph representation example of the cluster set to be processed;

FIGS. 25 and 26 are a flowchart of one example of a software dividing procedure of the software dividing apparatus 100 according to the second embodiment;

FIGS. 27 and 28 are a flowchart of one example of a specific procedure of relationship graph converting processing;

FIG. 29 is a flowchart of one example of a specific procedure of second integration processing; and

FIG. 30 is an explanatory diagram of a software division example.

### DESCRIPTION OF EMBODIMENTS

Embodiments of a software dividing program, a software dividing apparatus, and a software dividing method will be described in detail with reference to the accompanying drawings.

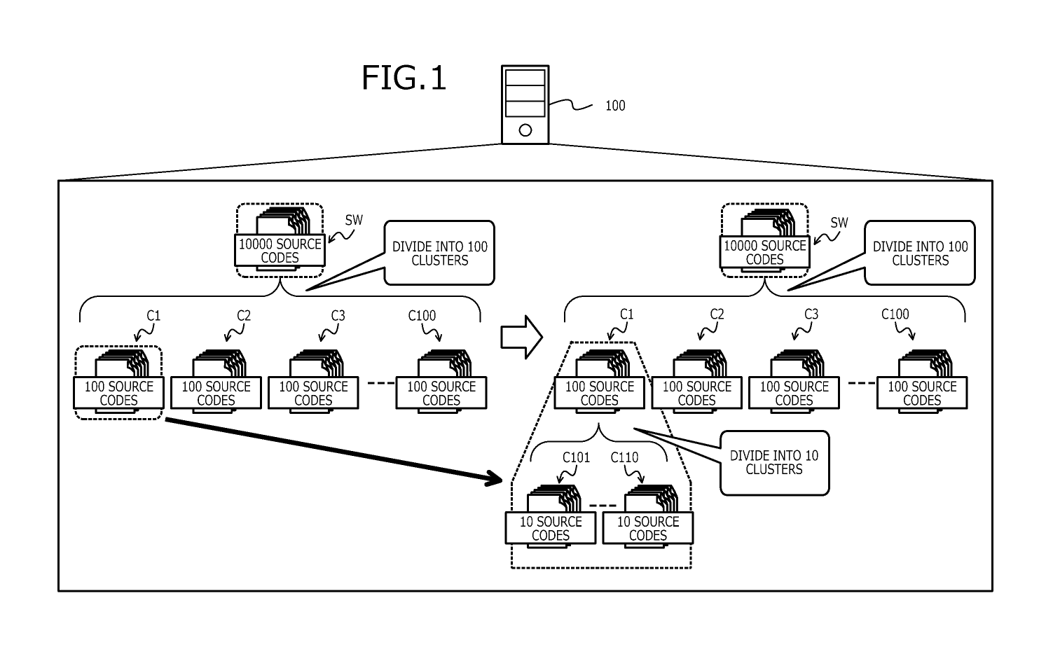

FIG. 1 is an explanatory diagram of an example of a software dividing method according to a first embodiment. In FIG. 1, a software dividing apparatus 100 is a computer that divides software. The software is a computer program to be divided and is a description of instructions, procedures, etc. that cause the computer to operate, the description being in a format understandable to the computer.

Software can be represented by, for example, a directed graph structure having an entity as a constituent element of the software as a node and a dependence relationship between the entities as a directed edge. In the following description, the directed edge is abbreviated simply as “edge” and the directed graph structure is abbreviated simply as “graph”.

The entity is, for example, a component, a module, source code, a class, a function, a database, a file, etc. The dependence relationship between the entities is, for example, a relationship such as a call relationship, an inheritance relationship, an inclusion relationship, and a data access relationship of the component, the module, the source code, the class, the function, etc.

While an understanding of software is important for development, improvement, and maintenance of the software, the software structure becomes complicated as the scale of the software becomes larger. For this reason, the software is sometimes divided into manageable, small-scale units so that the software can be understood instinctively and easily.

The division of software is, for example, to divide a graph into subgraphs. A set of entities that are nodes belonging to each of the subgraphs into which the graph is divided is called a cluster. Namely, the division of software is to seek, for a set of entities as constituent elements of the software, a set of clusters to which the entities belong.

When the scale of the software becomes large, however, even if the software is divided into plural clusters (subgraphs), the number of the entities within the cluster is too large and the software can become difficult to interpret by a human. For example, in large scale software of more than several thousand source files (classes), the number of entities within a cluster can be more than 50 and such a cluster is difficult to understand by a human.

To reduce the number of entities within the cluster, it is conceivable to migrate the entities from the cluster that has too large a number of entities and is difficult to interpret, to the cluster having a small number of entities. If there is no cluster having a small number of entities, however, the entities cannot be migrated between the clusters.

Further, migration of the entities between the clusters means a change to the results of the division of the software. For this reason, even if the software is divided by an optimum clustering algorithm, the change to such results of division makes the division results not optimum and results in a significant lowering of quality in terms of achieving an optimum division.

Therefore, in the first embodiment, the software dividing apparatus 100 recursively repeats the division of the software, treating a set of entities within the cluster as one new software, until the number of entities within the cluster obtained by dividing the software becomes equal to or smaller than a pre-determined upper-limit number of the entities. By this, the software is divided into subsets of such a small scale as to be understood by a human. An example will be described of software division processing by the software dividing apparatus 100.

(1) The software dividing apparatus 100, according to a selection of an entity set to be processed among an entity group as a constituent element group of the software, divides the entity set to be processed into plural clusters. The software division by the software dividing apparatus 100 has, for example, properties (i) to (iii) below.

(i) The software division is executed by grouping the entities, stressing the entity and the dependence relationship as main matters of processing of the software, in the software as a set of entities. (ii) The software division is executed so as to disregard the entity and the dependence relationship that are not essential and are obstructive to understanding and remove such an entity and dependence relationship from a divided group if necessary. (iii) However, the software division is executed so as to include the entity that at first glance appears to be disregarded but characterizes a divided group, in the group.

For example, the software dividing apparatus 100 divides the entity set to be processed into plural clusters, based on a weight related to the dependence relationship between the entities, so that a total of the weights related to the dependence relationship between the entities within a same cluster will become higher than an expected value of the total.

The weight related to the dependence relationship between the entities is a degree of how essential the dependence relationship is for an entity as a source of relationship to fulfill the role, in the dependence relationship between the entities. The role indicates a function, a task, a work, etc., realized by the software.

The weight related to the dependence relationship between the entities is identified by the dependence relationship between the entities of the entity group and is used as the weight of the edge connecting the entities as the nodes of the graph. An example will be described later of the calculation of the weight related to the dependence relationship between the entities based on such dependence relationship.

Namely, to satisfy the properties (i) to (iii) above, the software dividing apparatus 100 performs clustering so that a total of the weights of the edges within the cluster will become larger than the expected value thereof. If the properties (i) to (iii) are satisfied, then the entities characterizing a cluster are included within the cluster.

In the example of FIG. 1, software SW to be processed (group of 10000 source codes) is divided into 100 clusters C1 to C100. The number of entities (number of source codes) within each of the clusters C1 to C100 is 100.

(2) The software dividing apparatus 100 judges if the number of entities within any cluster among the plural clusters into which the software SW was divided is greater than the pre-stored upper-limit number of entities. The upper-limit number of entities is arbitrarily pre-set and is stored in the software dividing apparatus 100. For example, the upper-limit number of entities is set at such a value that, if exceeded by the number of entities within the cluster, makes it difficult for a human to interpret the cluster, taking into account the skill of a person who analyzes the software and the manageability of the software.

The example depicted in FIG. 1 assumes a case in which the upper-limit number of entities is set at “50”. In this case, the software dividing apparatus 100 judges that all of the clusters C1 to C100 exceed the upper-limit number of entities.

(3) The software dividing apparatus 100, according to the number of entities within a cluster exceeding the upper-limit number of entities, selects the entity set within the cluster as the entity set to be processed. The software dividing apparatus 100 then divides the entity set to be processed into plural clusters.

Namely, the software dividing apparatus 100, treating the cluster exceeding the upper-limit number of entities as a new software, performs the clustering again. Thereafter, the software dividing apparatus 100 repeats a sequence of the processing from (1) to (3) until, for example, there is no remaining cluster exceeding the upper-limit number of entities.

For example, taking as an example, the cluster C1, which exceeds the upper-limit number of entities, the software dividing apparatus 100 selects the entity set (100 source codes) within the cluster C1 as the entity set to be processed. The software dividing apparatus 100 divides the entity set (100 source codes) within the cluster C1 into plural clusters.

As a result, in the example of FIG. 1, 100 source codes within the cluster C1 are divided into 10 clusters of C101 to C110. The number of entities (number of source codes) within each of the clusters C101 to C110 is 10. By this, a division of a lower layer having the cluster C1 as a parent cluster is obtained and a hierarchical structure of the cluster is formed.

Thus, the software dividing apparatus 100 can recursively repeat the division of the software, treating the entity set within the cluster as one new software, until the number of entities within the cluster obtained by dividing the software SW becomes equal to or smaller than the upper-limit number of entities.

This makes it possible to introduce the hierarchical structure into the division of the software SW so that the software SW will be divided into subsets of such a small scale as to be understood by a human. It becomes possible to perform the software division by a nested structure by which the cluster level becomes multi-layered, such as, for example, the software SW being divided into the clusters C1 to C100, each of the clusters C1 to C100 being divided into plural small clusters (e.g., clusters C101 to C110), and each small cluster storing plural entities. Since the results of the division obtained by using the clustering algorithm having the properties (i) to (iii) above are not arbitrarily processed, an optimum solution of the division results can be prevented from being impaired.

Even if the number of entities within the cluster is in excess of the upper-limit number of entities, when no further improvement can be made, namely, the cluster cannot be further divided, the software dividing apparatus 100 terminates the division of the cluster. A graph structure will be described of the cluster when no further improvement can be made even if the number of entities within the cluster is in excess of the upper-limit number of entities.

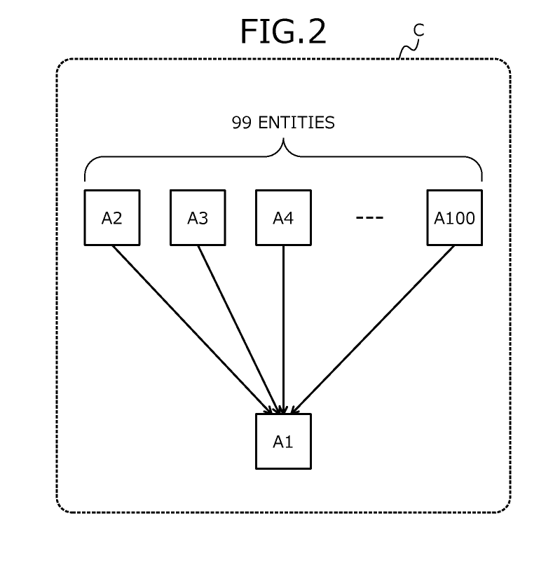

FIG. 2 is an explanatory diagram of one example of the graph structure of the cluster that cannot be improved. In FIG. 2, entities A1 to A100 are an entity set belonging to cluster C. The entity A1 is the entity to be individually called from 99 entities A2 to A100.

In this case, even if the number of entities within the cluster C is in excess of the upper-limit number of entities, there is no reasonable choice of further dividing the cluster C. Because of a simple structure of having the entity A1 called from the entities A2 to A100, the cluster C can be easily understood by a human even if the upper-limit number of entities is exceeded. For this reason, the software dividing apparatus 100 does not further divide the cluster C.

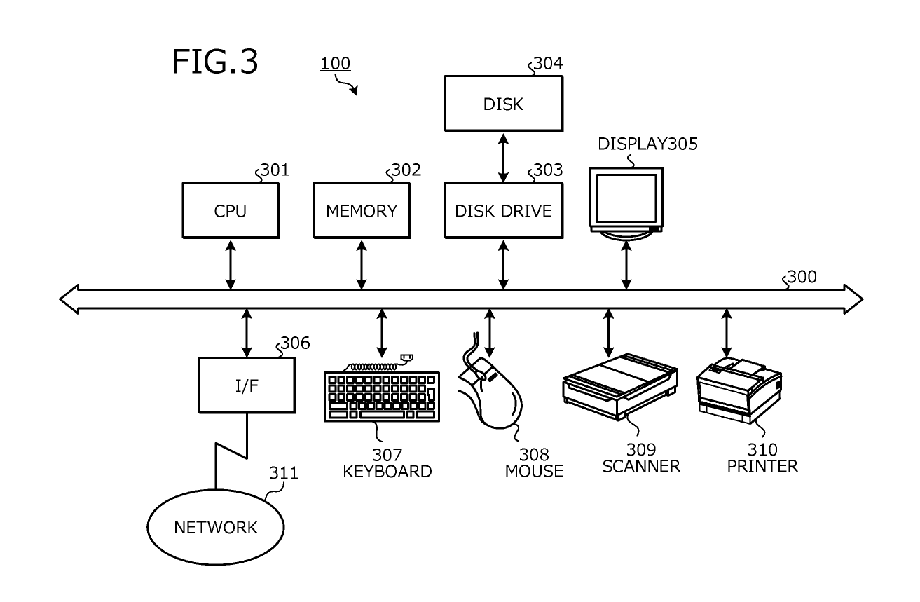

FIG. 3 is a block diagram depicting an example of a hardware configuration of the software dividing apparatus 100. In FIG. 3, the software dividing apparatus 100 includes a central processing unit (CPU) 301, memory 302, a disk drive 303, a disk 304, a display 305, an interface (I/F) 306, a keyboard 307, a mouse 308, a scanner 309, and a printer 310, respectively connected by a bus 300.

The CPU 301 governs overall control of the software dividing apparatus 100. The memory 302 includes, for example, read-only memory (ROM), random access memory (RAM) and flash ROM. More specifically, for example, the flash ROM and the ROM store various types of programs, and the RAM is used as a work area of the CPU 301. The programs stored by the memory 302 are load onto the CPU 301, whereby encoded processes are executed by the CPU 301.

The disk drive 303, under the control of the CPU 301, controls the reading and writing od data with respect to the disk 304. The disk 304 stores the data written thereto under the control of the disk drive 303. A magnetic disk, an optical disk, and the like may be used as the disk 304.

The display 305 display for example, data such as texts, images, functional information, etc., in addition to a cursor, icons, or tool boxes. A cathode ray tube (CRT), a thin-film-transistor (TFT) liquid crystal display, a plasma display, etc., may be employed as the display 305.

The I/F 306 is connected to a network 311 through a communication line and is connected to other apparatuses through the network 311. The I/F 306 administers an internal interface with the network 311 and controls the input and output of data with respect to external apparatuses. For example, a modem or a LAN adaptor may be employed as the I/F 306.

The keyboard 307 includes, for example, keys for inputting letters, numerals, and various instructions and performs the input of data. Alternatively, a touch-panel-type input pad or numeric keypad, etc. may be adopted. The mouse 308 is used to move the cursor, select a region, or move and change the size of windows.

The scanner 309 optically reads an image and takes in the image data into the software dividing apparatus 100. The scanner 309 may have an optical character reader (OCR) function as well. The printer 310 prints image data and text data. The printer 310 may be, for example, a laser printer or an ink jet printer.

Among the components described above, the software dividing apparatus 100 may omitted, for example, the scanner 309, the printer 310, etc.

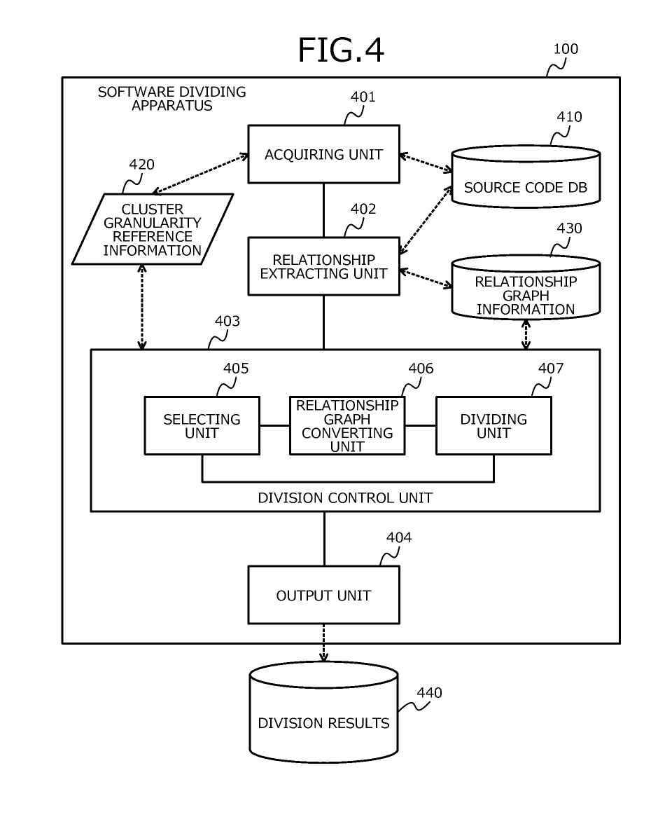

FIG. 4 is a block diagram depicting an example of a functional configuration of the software dividing apparatus 100 according to the first embodiment. In FIG. 4, the software dividing apparatus 100 is configured to include an acquiring unit 401, a relationship extracting unit 402, a division control unit 403, and an output unit 404. The acquiring unit 401 to the output unit 404 represent a function as a control unit and for example, functions are realized by causing the CPU 301 to execute a program stored in a storage device such as the memory 302 and the disk 304 depicted in FIG. 3, or by the I/F 306. Results of processing by each functional unit are stored in, for example, a storage device such as the memory 302 and the disk 304.

The acquiring unit 401 has a function of acquiring the source code of the software SW to be divided. For example, the acquiring unit 401 acquires the source code of the software SW by user operation input via the keyboard 307 and the mouse 308 depicted in FIG. 3. The acquiring unit 401 may acquire the source code of the software SW from an external computer, for example, by way of the network 311 depicted in FIG. 3.

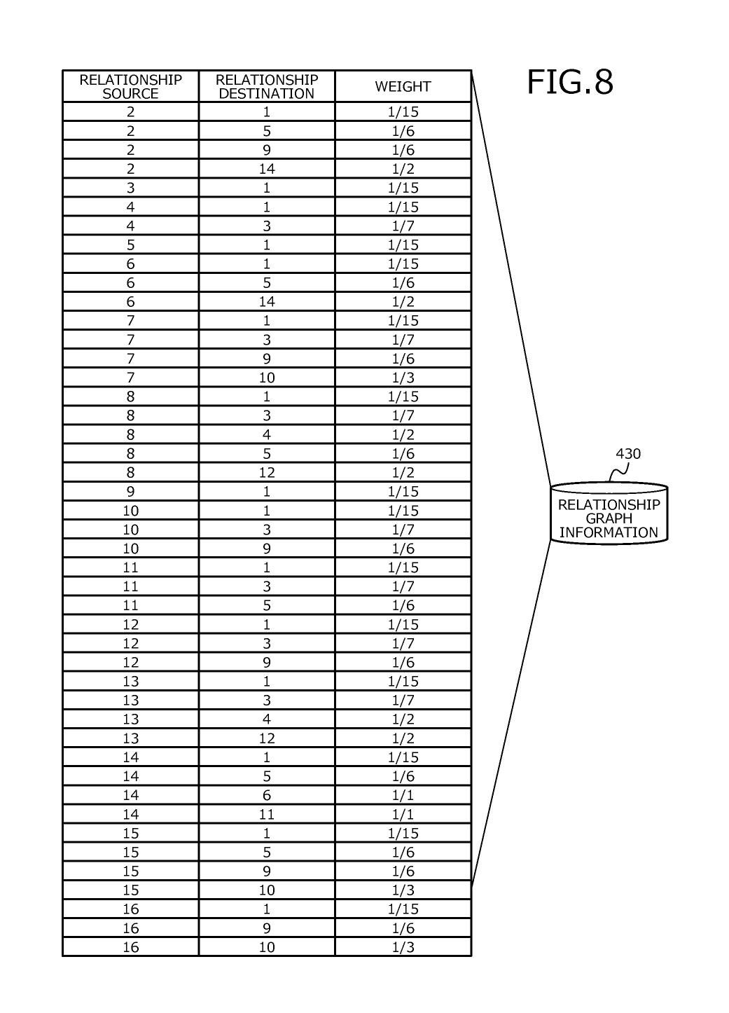

The acquired source code of the software SW is stored in a source code database (DB) 410. The source code DB 410 stores the source code (e.g., source codes 701 and 702 depicted in FIG. 7 to be described later) of the software SW. The source code DB 410 is realized, for example, by a storage device such as the memory 302 and the disk 304 depicted in FIG. 3.

The acquiring unit 401 has a function of acquiring cluster granularity reference information 420. The cluster granularity reference information 420 is the information indicative of the upper-limit number of clusters and the upper-limit number of entities, correlated to each other. For example, the acquiring unit 401 acquires the cluster granularity reference information 420 by user operation input via the keyboard 307 and the mouse 308.

The acquiring unit 401 may acquire the cluster granularity reference information 420 from an external computer, for example, by way of the network 311. The acquired cluster granularity reference information 420 is stored in, for example, a storage device such as the memory 302 and the disk 304.

A specific example will be described of the cluster granularity reference information 420.

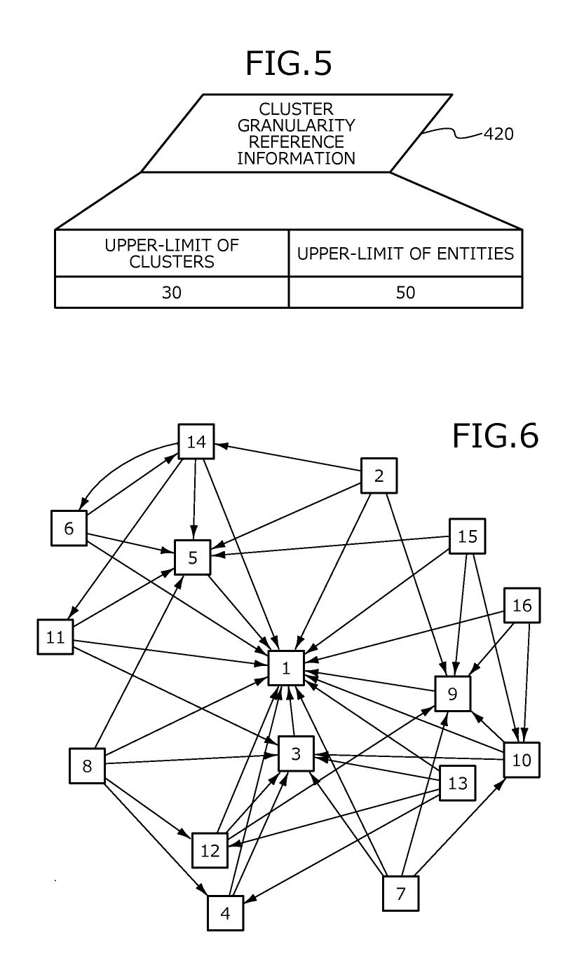

FIG. 5 is an explanatory diagram of a specific example of the cluster granularity reference information 420. In FIG. 5, the cluster granularity reference information 420 indicates the upper-limit number of clusters “30” and the upper-limit number of entities “50”, correlated to each other. The upper-limit number of clusters “30” and the upper-limit number of entities “50” are set, for example, taking into account the skill of the person who analyzes the software SW and the manageability of the software SW.

Reference of the description returns to FIG. 4. The relationship extracting unit 402 has a function of extracting the dependence relationship between the entities as the constituent elements of the software SW. For example, the relationship extracting unit 402 reads in the source code of the software SW from the source code DB 410 and analyzes the source code by conventional syntax analyzing technology and static analyzing technology. The relationship extracting unit 402 extracts the dependence relationship between the entities by extracting from the analyzed source code a combination of the entity as a source of the relationship and the entity as a destination of the relationship.

A graphic representation of the software SW will be described.

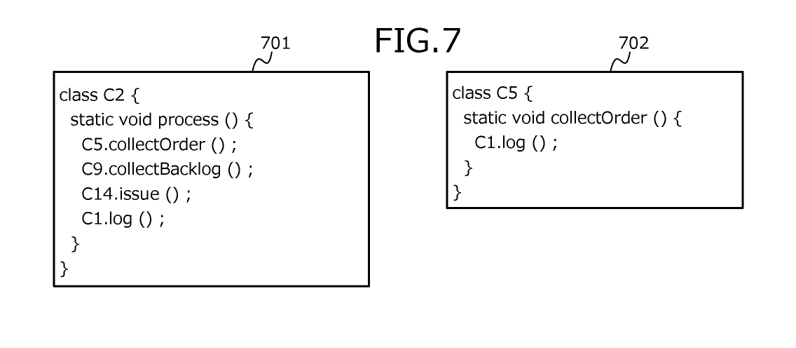

FIG. 6 is an explanatory diagram of a graphic representation example of the software SW. In FIG. 6, a square figure denotes an entity as a constituent element of the software SW. In the example of FIG. 6, the number of entities as constituent elements of the software SW is set at 16. An arrow between the entities denotes the dependence relationship. A starting end of the arrow is taken as the source entity of the relationship and a terminating end of the arrow (tip of arrow) is taken as the destination entity of the relationship.

For example, when the dependence relationship represents a call relationship, the source entity of the relationship calls the destination entity of the relationship. For example, each entity represents, for example, a class of the Java (registered trademark) language. An entity number corresponds to a class number depicted in FIG. 7 to be described later. For example, an entity # (# meaning “numeral”) corresponds to a class C#.

FIG. 7 is an explanatory diagram of a source code example of the software SW. In the example of FIG. 7, description is made taking the source code of the Java language as an example. In FIG. 7, the source code 701 is source code representing class C2, which calls classes C5, C9, C14, and C1. The source code 702 is a source code representing class C5, which calls class C1.

For example, the relationship extracting unit 402 extracts, from the source code 701, class C2 as the source entity of the relationship. The relationship extracting unit 402 extracts, from the source code 701, classes C5, C9, C14, and C1 called by class C2 as the destination entities of the relationship of class C2. This results in the extraction of the dependence relationship between the entities. Likewise, with respect to the source code 702, the relationship extracting unit 402 extracts class C5 as the source entity of the relationship and extracts class C1 as the destination entity of the relationship.

The relationship extracting unit 402 stores the extracted combination of the source entity of the relationship and the destination entity of the relationship, as a record of relationship graph information 430. The relationship graph information 430 is the information representing the software SW by a graph structure having the entity as a constituent element of the software SW as the node and the dependence relationship between the entities (or clusters) as the edge.

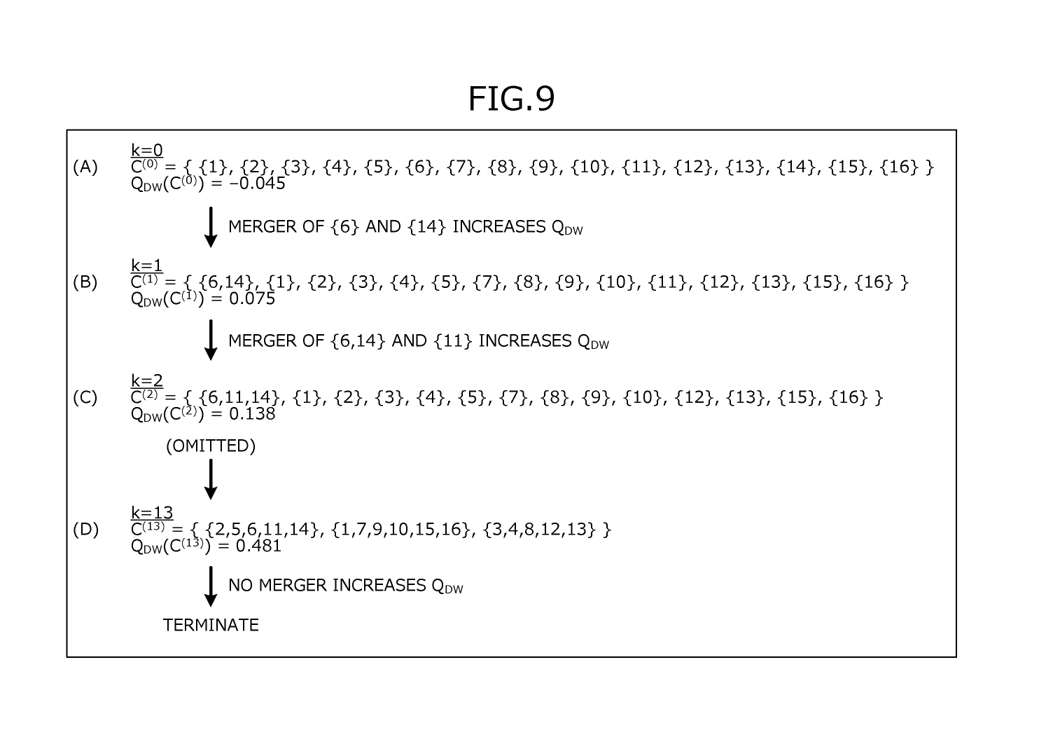

For example, in the case of the source code 701, the relationship extracting unit 402 stores {2, 5}, {2, 9}, {2, 14}, and {2, 1} in the relationship graph information 430. {a, b} denotes a combination of number a of the source entity of the relationship and number b of the destination entity of the relationship. A specific example of the relationship graph information 430 will be described later with reference to FIG. 8.

The relationship extracting unit 402 has a function of calculating a degree of essentiality from the source entity of the relationship to the destination entity of the relationship. The degree of essentiality indicates how essential the dependence relationship is for the source entity of the relationship to fulfill a role, in the dependence relationship between the entities. The role indicates a function, a task, work, etc., realized by the software SW.

The degree of essentiality corresponds to the weight related to the dependence relationship between the entities described above. The degree of essentiality is given for each dependence relationship between the entities and is used as a weight of the edge corresponding to the dependence relationship. For example, the degree of essentiality can be expressed using equation (1).

$$E ( A , B ) = \frac{1}{{d}_{in} ( B )} \qquad ( 1 )$$

In equation (1) above, E(A, B) on the left-hand side denotes the degree of essentiality of the dependence relationship from entity A to entity B. dᵢₙ (B) of a denominator on the right-hand side denotes an indegree of entity B. The indegree is the number of edges in which entity B becomes the destination entity of the relationship or the number of relationships of being depended on.

For the right-hand side of equation (1) above, a different form may be used such as, for example, a relative size value of entity B and a predetermined importance degree numerical value.

The relationship extracting unit 402 stores the calculated degree of essentiality, correlated to the combination of the source entity of the relationship and the destination entity of the relationship, as the weight of the edge corresponding to the dependence relationship between the entities, in the relationship graph information 430. By this, the relationship graph information 430 of the software SW is generated. The relationship graph information 430 is stored in, for example, a storage device such as the memory 302 and the disk 304.

A specific example will be described of the relationship graph information 430.

FIG. 8 is an explanatory diagram of a specific example of the relationship graph information 430. In FIG. 8, the relationship graph information 430 depicts the source of the relationship, the destination of the relationship, and the weight, correlated to one another. The source of the relationship indicates the source entity of the relationship. The destination of the relationship indicates the destination entity of the relationship. The weight is the degree of the essentiality from the source entity of the relationship to the destination entity of the relationship and indicates the weight of the edge corresponding to the dependence relationship between the entities.

Here, the weight is expressed by the reciprocal of the indegree to the destination entity of the relationship. For example, in the record at a first line of the relationship graph information 430, the source entity of the relationship is “2 (C2)” and the destination entity of the relationship is “1 (C1)”. Since the number of edges becoming the indegree of 1 (C1) as the destination entity of the relationship is 15 (see FIG. 6), the weight becomes “ 1/15”.

Reference of the description returns to FIG. 4. The division control unit 403 has a function of clustering the software SW. The clustering is to express the software SW by a graph and divide the graph into clusters. A cluster is a subgraph or a set of entities belonging to the subgraph, when a graph of the software SW is divided into the subgraphs.

For example, the division control unit 403 has a selecting unit 405, a relationship graph converting unit 406, and a dividing unit 407. Specific processing details will be described of each functional unit of the division control unit 403.

The selecting unit 405 has a function of selecting an entity set to be processed out of an entity group as a constituent element group of the software SW. The entity set to be processed is the entity set within the cluster in which the number of entities within the cluster is in excess of the upper-limit number of entities.

To describe in more detail, the entity set to be processed is a set of the entities belonging to the subgraph in which the criteria of the upper-limit number of entities are not satisfied when the software SW is expressed by the graph and the graph is divided into the subgraphs. The upper-limit number of entities is identified, for example, by the cluster granularity reference information 420 depicted in FIG. 5.

In an undivided state in which the software SW is not divided, however, the selecting unit 405 selects, for example, a whole of the entity group as the constituent element group of the software SW, as the entity set to be processed.

The relationship graph converting unit 406 has a function of generating new relationship graph information R by extracting records of the entity set to be processed, selected by the selecting unit 405, from the relationship graph information 430 generated by the relationship extracting unit 402.

For example, the relationship graph converting unit 406 generates the relationship graph information R by extracting the record corresponding to each edge of the subgraph to be processed, from the relationship graph information 430. However, in the undivided state in which the software SW is not divided, for example, the relationship graph information 430 becomes the relationship graph information R.

The dividing unit 407, according to the selection of the entity set to be processed, has a function of dividing the entity set to be processed into plural clusters, based on the weight related to the dependence relationship between the entities of the entity group to be identified by such dependence relationship.

For example, to satisfy the properties (i) to (iii) above, the dividing unit 407 divides the entity set to be processed into plural clusters, based on the generated relationship graph information R, so that a total of the weights related to the dependence relationship within a same cluster will be higher than an expected value of the total.

For example, the dividing unit 407 uses the technology of Japanese Laid-Open Patent Publication No. 2013-148987 cited as the known technology document, as the clustering algorithm satisfying the properties (i) to (iii) above. Japanese Laid-Open Patent Publication No. 2013-148987 represents a technology, using a modularity evaluation function Q_{DW} as a measure of good clustering of a graph, of searching for a clustering (division into clusters) for which the modularity evaluation function Q_{DW} comes to a maximum, by a greedy algorithm.

The modularity evaluation function Q_{DW} is defined, for example, by equation (2).

$${Q}_{DW} ( C ) = \frac{1}{m} {\sum }_{ij} [ {A}_{ij} - \frac{{k}_{i}^{OUT} {k}_{j}^{IN}}{m} ] δ ( {c}_{i} , {c}_{j} ) \qquad ( 2 )$$

In equation (2) above, Aᵢⱼ is an element of an adjacency matrix A of the graph. A subscript i denotes the number of the node as the source entity of the relationship (or the cluster as the source of the relationship). A subscript j denotes the number of the node as the destination entity of the relationship (or the cluster as the destination of the relationship). The value of the element of the adjacency matrix A is the weight of the edge and is non-negative. The value larger than 0 means availability of the edge and the value of 0 means unavailability of the edge. Because of the directed graph, the adjacency matrix A is an asymmetric matrix.

kᵢ^{OUT} denotes a total of the weights of the edges in which the node i becomes the source entity of the relationship (or cluster as the source of the relationship). For example, kᵢ^{OUT} is expressed by equation (3).

kᵢ^{OUT}=ΣⱼAᵢⱼ (3)

kⱼ^{IN} is a total of the weights of the edges in which the node j becomes the destination entity of the relationship (or cluster as the destination of the relationship). For example, kⱼ^{IN} is expressed by equation (4).

kⱼ^{IN}=ΣᵢAᵢⱼ (4)

m is a total of the weights (element Aᵢⱼ) of the edges and is a sum of element Aᵢⱼ of adjacency matrix A. For example, m is expressed by equation (5).

m=ΣᵢΣⱼAᵢⱼ (5)

cᵢ denotes the cluster to which the node i belongs. It is assumed that each node belongs to any of the clusters. C denotes a partition and is a set of cᵢ (C={cᵢ}).

δ(cᵢ, cⱼ) is the Kronecker delta function. Namely, if cluster Cᵢ and cluster cⱼ are the same, then δ (cᵢ, cⱼ)=1 and if cluster Cᵢ and cluster c are different, then δ (cᵢ, cⱼ)=0.

The range of the modularity evaluation function Q_{DW} becomes [−1, 1] and a greater value means a better clustering, a smaller value meaning a poorer clustering. However, actual upper-limit and lower-limit values are dependent on the graph and actually, it is rare that the upper-limit value comes close to 1.

The intent of equation (2) above will be described. The Kronecker delta function δ (cᵢ, cⱼ) is a function to take into account only the edges within the cluster, disregarding the edges outside the cluster. Due to the Kronecker delta function δ (cᵢ, cⱼ), the equation becomes an equation regarding the edges present within each cluster. Namely, if the cluster cᵢ and the cluster cⱼ are different, then δ (cᵢ, cⱼ)=0 and therefore, the contribution to the modularity evaluation function Q_{DW} is zero.

Adjacency matrix Aᵢⱼ is the weight of the edge from node i to node j. Since an expected value of the weighted probability of the edge going out of node i is kᵢ^{OUT}/m and an expected value of the weighted probability of the edge coming into node j is kⱼ^{IN}/m, an expected value of the weight of the edge from entity i (or cluster i) to entity j (or cluster j) is expressed by equation (6).

m·(kᵢ^{OUT}/m)·(kⱼ^{IN}/m)=kᵢ^{OUT}·kⱼ^{IN}/m (6)

The right-hand side of equation (6) above is a part of equation (2) above. Namely, the modularity evaluation function Q_{DW} is the sum, with respect to the clusters, of a difference between the total of the degrees of essentiality of the edges belonging to each cluster and the expected value thereof, which is normalized so that the value range will be [1, −1].

In a more intuitive expression, it can be said that the modularity evaluation function Q_{DW} becomes high when the total of the degrees of essentiality (weights) of the edges within the cluster is greater than the expected value thereof. In other words, it can be said that the modularity evaluation function Q_{DW} becomes high when the density of the degree of essentiality of the edges within the cluster is high and that the modularity evaluation function Q_{DW} becomes high when the total of the degrees of essentiality of the edges outside the cluster is small.

The dividing unit 407, based on the relationship graph information R, divides the entity set to be processed into plural clusters so that equation (2) above will be maximized. A process will be described of the clustering using the degree of essentiality (weight). Firstly, a definition and a notation will be described of symbols used in the process of the clustering using the degree of essentiality (weight).

A set of all nodes of the graph is given as V. The node represents an entity (or cluster). The node is expressed by a sequential-number integer of 1 or more and the number of nodes is given as n. Namely, V={1, 2, . . . , n}. A certain partition of V is expressed by C. C is a set having nonempty, pairwise disjoint subsets Sᵢ of V as elements and is expressed as C={S₁, S₂, . . . S_{|C|}}. |C| means the number of elements of partition C.

Then, set V is expressed by equation (7).

S₁∪S₂∪ . . . ∪S_{|C|}=V (7)

When node i is an element of Sₓ, cluster cᵢ of node i is obtained as x. Namely, if partition C is determined, the value of the modularity evaluation function Q_{DW} is determined. In this case, it is expressed as Q_{DW}(C). C[i, j] obtained by merging two different elements Sᵢ and Sⱼ within partition C is defined by equation (8).

C[i,j]=(C−{Sᵢ}−{Sⱼ})∪{Sᵢ∪Sⱼ} (8)

In equation (8) above, A-B means a set difference by excluding the elements of set B from set A. Partition C in a certain state k is given as C^{(k)}={S^{(k)}₁, S^{(k)}₂, . . . , S^{(k)}_{|C(k)|}}. For example, in C={S₁, S₂, S₃, S₄}, in the case of merging the subsets S₁ and S₂, partition C[i, j] after the merger becomes C[i, j]=C[1, 2]={S₁∪S₂, S₃, S₄}. S₁∪S₂ is a union of subsets S₁ and S₂.

The process will be described of the clustering using the degree of essentiality (weight) in the case of using the relationship graph information 430 depicted in FIG. 8.

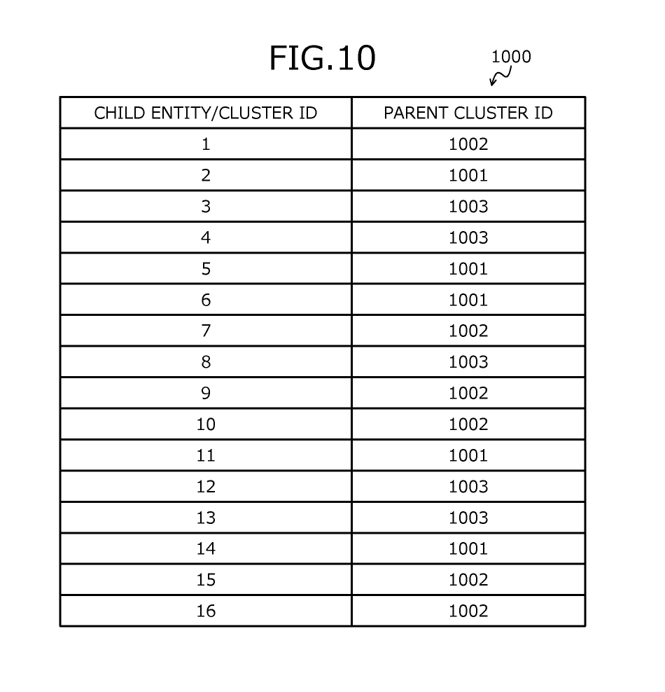

FIG. 9 is an explanatory diagram of one example of the process of the clustering. In FIG. 9, the modularity evaluation function Q_{DW} of partition C in state k is given as Q_{DW}(C^{(k)}).

(A) indicates partition C⁽⁰⁾ in the initial state (k=0). In the initial state, one node becomes one cluster. The modularity evaluation function Q_{DW}(C⁽⁰⁾) in this case is Q_{DW}(C⁽⁰⁾)=−0.045. From this state, two subsets are merged in the round-robin system and the merger of the two subsets by which Q_{DW} after merger becomes the highest is employed and this is taken in as the next state (k=1). In this case, the merger of subsets {6} and {14} is the merger by which Q_{DW} becomes the highest.

(B) indicates partition C⁽¹⁾ in the next state (k=1). The modularity evaluation function Q_{DW}(C⁽¹⁾) in this case is Q_{DW}(C⁽¹⁾)=0.075. From this state, two subsets are merged in the round-robin system and the merger of the two subsets by which Q_{DW} after merger becomes the highest is employed and this is taken in as the next state (k=2). In this case, the merger of subsets {6, 14} and {11} is the merger by which Q_{DW} becomes the highest.

(C) indicates partition C⁽²⁾ in the next state (k=2) after (B). The modularity evaluation function Q_{DW}(C⁽²⁾) in this case is Q_{DW}(C⁽²⁾)=0.138. From this state, two subsets are merged in the round-robin system and the merger of the two subsets by which Q_{DW} after merger becomes the highest is employed and this is taken in as the next state (k=3). This processing is repeatedly performed.

(D) indicates partition C⁽¹³⁾ in the state of k=13 when the process has been repeated 13 times from the initial state. Q_{DW}(C⁽¹³⁾)=0.481. From this state, two subsets are merged by the round-robin system. In k=13, there are the merger of subsets {2, 5, 6, 11, 14} and {1, 7, 9, 10, 15, 16}, the merger of subsets {2, 5, 6, 11, 14} and {3, 4, 8, 12, 13}, and the merger of subsets {1, 7, 9, 10, 15, 16} and {3, 4, 8, 12, 13}.

Since Q_{DW}(C⁽¹³⁾)=0.481 is not surpassed in any of the three mergers, the clustering ends at partition C⁽¹³⁾. By this, the software is divided into three subsets {2, 5, 6, 11, 14}, {1, 7, 9, 10, 15, 16}, and {3, 4, 8, 12, 13}.

A specific example will be described of results of the division by the dividing unit 407. The division results become interim results (division results before integration) of the software dividing apparatus 100.

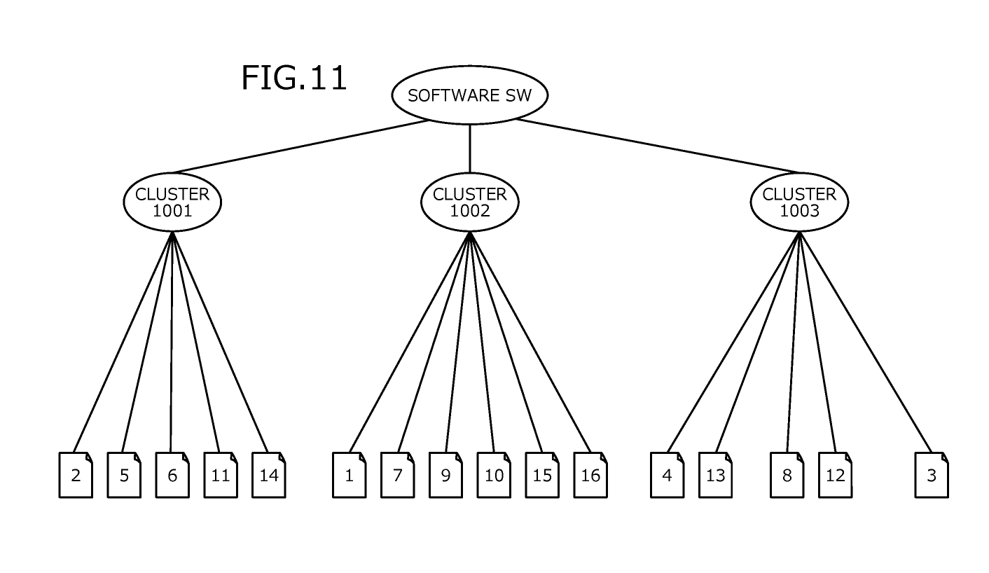

FIG. 10 is an explanatory diagram of a specific example of the division results before integration. In FIG. 10, division results 1000 are information indicative of a child entity/cluster ID and a parent cluster ID, correlated to each other. The child entity/cluster ID is an identifier to identify the entity or the cluster within the divided cluster. The parent cluster ID is an identifier to identify the divided cluster.

In the example of FIG. 10, the software SW is divided into three subsets. Parent cluster ID “1001” is assigned to subset {2, 5, 6, 11, 14}, parent cluster ID “1002” to subset {1, 7, 9, 10, 15, 16}, and parent cluster ID “1003” to subset {3, 4, 8, 12, 13}.

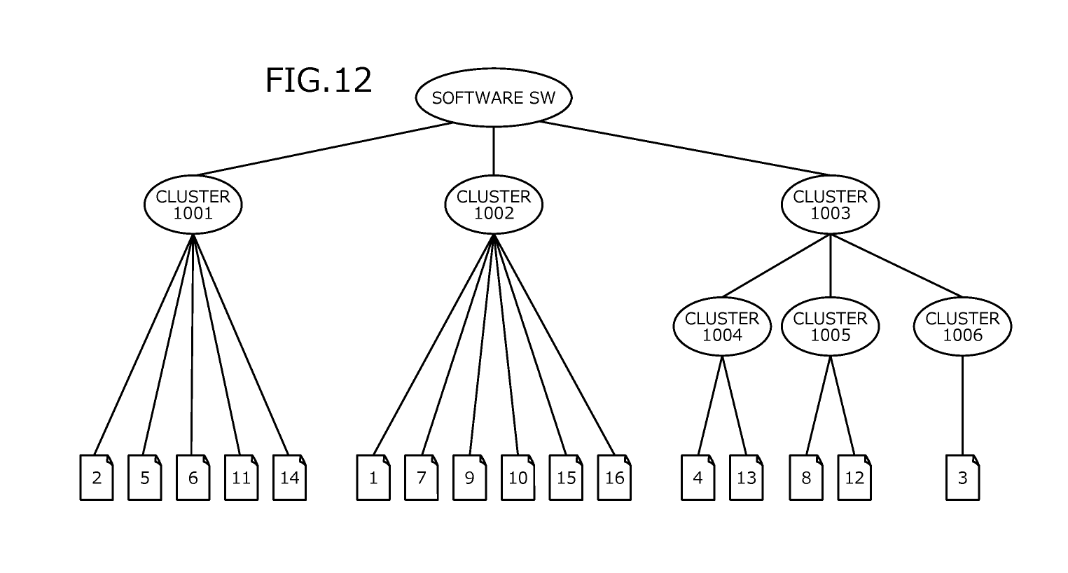

For example, the first line of the division results 1000 indicates that entity 1 belongs to cluster 1002. Namely, the division results 1000 makes it possible to grasp the hierarchical structure of the software SW as depicted in FIG. 11.

FIG. 11 is an explanatory diagram (part 1) of a hierarchical structure example of the software SW. In FIG. 11, the software SW is represented as hierarchically structured. For example, the software SW is divided into three clusters 1001 to 1003. Five entities of 2, 5, 6, 11, and 14 belong to cluster 1001. Six entities of 1, 7, 9, 10, 15, and 16 belong to cluster 1002. Five entities of 3, 4, 8, 12, and 13 belong to cluster 1003.

Reference of the description returns to FIG. 4. The selecting unit 405, according to the number of entities within any cluster among plural divided clusters exceeding the upper-limit number of entities, selects the entity set within such a cluster as the entity set to be processed.

For example, the selecting unit 405 refers to the division results of the dividing unit 407 (e.g., division results 1000), judges, with respect to each divided cluster, whether the number of entities within the cluster exceeds the upper-limit number of entities. The selecting unit 405 then selects from within the cluster, an entity set exceeding the upper-limit number of entities as the entity set to be processed.

As a result, the cluster exceeding the upper-limit number of entities is deemed as one new software and new relationship graph information R is generated by the relationship graph converting unit 406. The entity set within the cluster is divided by the dividing unit 407 into plural clusters, based on the new relationship graph information R.

By this, the division of the entity set within the cluster of the lower-most layer is recursively repeated until there is no cluster exceeding the upper-limit number of entities. However, even if the number of entities within the cluster exceeds the upper-limit number of entities, the selecting unit 405 does not select the entity set within the cluster as the entity set to be processed, when the cluster cannot be improved any further as depicted in FIG. 2.

Namely, when any entity out of the entity set within the cluster exceeding the upper-limit number of entities are called from other entities, the selecting unit 405 does not select the entity set within the cluster as the entity set to be processed. This makes it possible to cut the dividing process of the cluster that cannot be improved any further, thereby reducing the processing load on the software dividing apparatus 100.

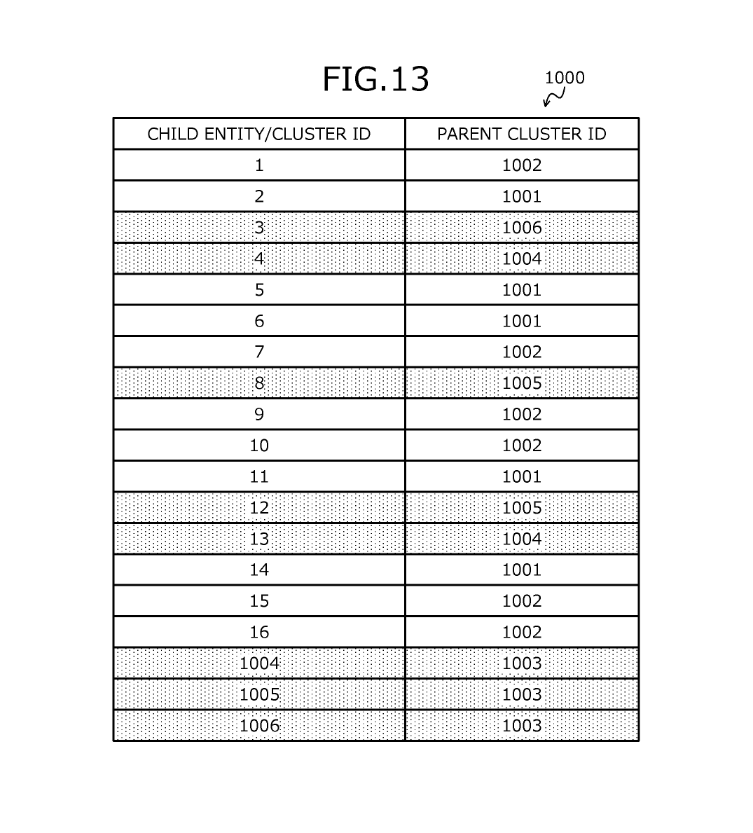

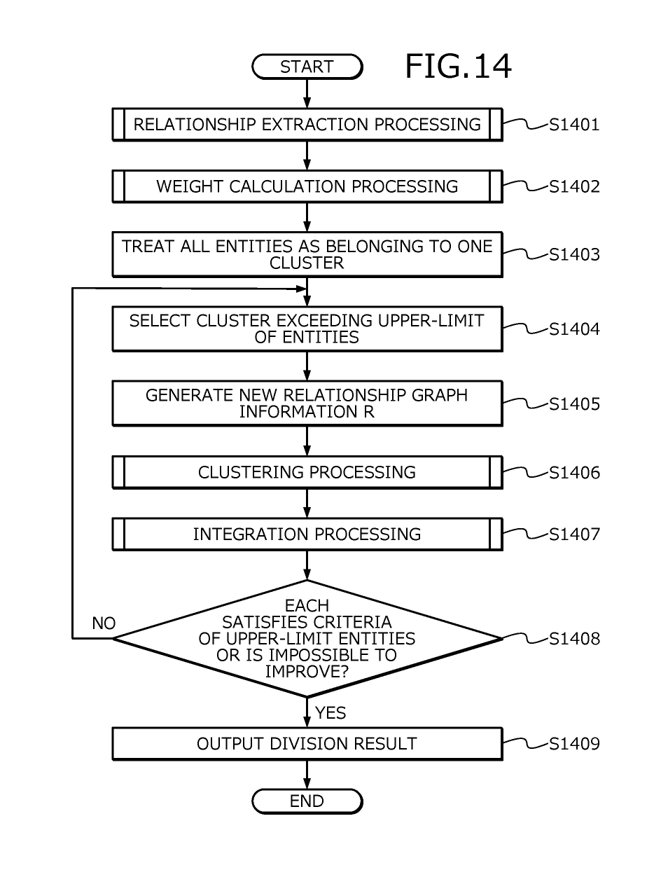

The relationship graph converting unit 406 has a function of integrating the division results of the dividing unit 407. For example, the relationship graph converting unit 406 integrates the division results of the entity set to be processed into overall division results. The overall division results mean the division results in the case of treating an entire entity group of the software SW as the entity set to be processed or the division results after the integration. An example of the integration of the division results will be described later with reference to FIGS. 12 and 13.

The output unit 404 outputs results of the clustering of the software SW by the division control unit 403 as division results 440. The clustering results are final integration results obtained by integrating the division results. Forms of output by the output unit 404 include, for example, storage to the storage device such as the memory 302 and the disk 304, display on the display 305, printout to the printer 310, transmission to an external computer by the I/F 306, etc.

An example will be described of the integration of the division results with reference to FIGS. 12 and 13. Description will be made using an example of a case of setting the upper-limit number of entities at “3” and regarding cluster 1003 depicted in FIGS. 10 and 11 as the cluster exceeding the upper-limit number of entities.

In this case, cluster 1003 is deemed as one new software and the entity set {3, 4, 8, 12, 13} within cluster 1003 becomes the entity set to be processed and is divided into plural clusters. It is assumed that the entity set {3, 4, 8, 12, 13} has been divided into clusters 1004 to 1006 as depicted in FIG. 12.

FIG. 12 is an explanatory diagram (part 2) of a hierarchical structure example of the software SW. In FIG. 12, the software SW is represented as hierarchically structured. For example, the software SW is divided into three clusters 1001 to 1003. Cluster 1003 is divided into three clusters 1004 to 1006.

Five entities of 2, 5, 6, 11, and 14 belong to cluster 1001. Six entities of 1, 7, 9, 10, 15, and 16 belong to cluster 1002. Two entities of 4 and 13 belong to cluster 1004. Two entities of 8 and 12 belong to cluster 1005. One entity 3 belongs to cluster 1006.

An example will be described of integration processing of the division results by the relationship graph converting unit 406, assuming that cluster 1003 has been divided into clusters 1004 to 1006.

In this case, the relationship graph converting unit 406 treats cluster 1003 as a source of division as cluster A. The relationship graph converting unit 406 assigns a parent cluster ID unused overall to each subset obtained by dividing the entity set {3, 4, 8, 12, 13} within cluster 1003.

For example, the relationship graph converting unit 406 assigns parent cluster ID “1004” to subset {4, 13}, parent cluster ID “1005” to subset {8, 12}, and parent cluster ID “1006” to subset {3}. The relationship graph converting unit 406 then selects any cluster out of clusters 1004 to 1006 as cluster X.

The relationship graph converting unit 406 extracts, for each child entity of cluster X, a corresponding line from the overall division results, namely, the division results 1000 depicted in FIG. 10 and replace the parent cluster ID of that line with the cluster ID of cluster X. The relationship graph converting unit 406 then adds a line having the cluster ID of cluster X as “the child entity/cluster ID” and the cluster ID of cluster A as “the parent cluster ID” to the overall division results 1000.

The relationship graph converting unit 406 repeats the same processing until there is no unselected cluster that has not yet been selected as cluster X from among clusters 1004 to 1006. This makes it possible to integrate new division results into the overall division results.

FIG. 13 is an explanatory diagram of a specific example of the division results after the integration. In FIG. 13, in the division results 1000 after the integration, as opposed to the division results before the integration (see FIG. 10), the parent cluster ID of entity 3 has been changed from “1003” to “1006”. The parent cluster ID of entity 4 has been changed from “1003” to “1004”.

The parent cluster ID of entity 8 has been changed from “1003” to “1005”. The parent cluster ID of entity 12 has been changed from “1003” to “1005”. The parent cluster ID of entity 13 has been changed from “1003” to “1004”.

Further, the line has been added that has “1004” as the “child entity/cluster ID” and “1003” as the “parent cluster ID”. The line has been added that has “1005” as the “child entity/cluster ID” and “1003” as the “parent cluster ID”. The line has been added that has “1006” as the “child entity/cluster ID” and “1003” as the “parent cluster ID”.

A software dividing procedure will be described of the software dividing apparatus 100 according to the first embodiment.

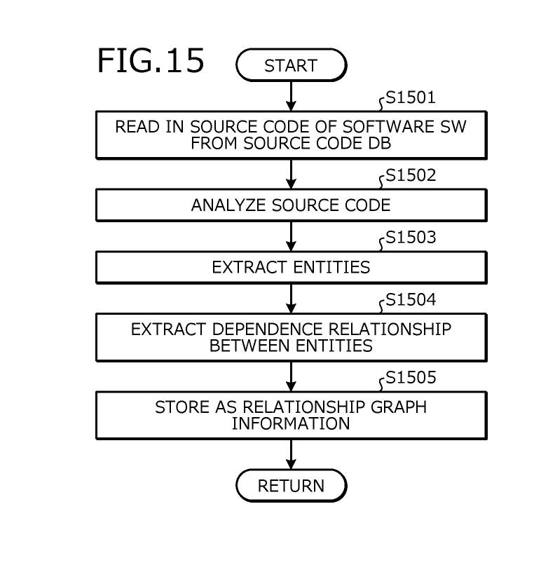

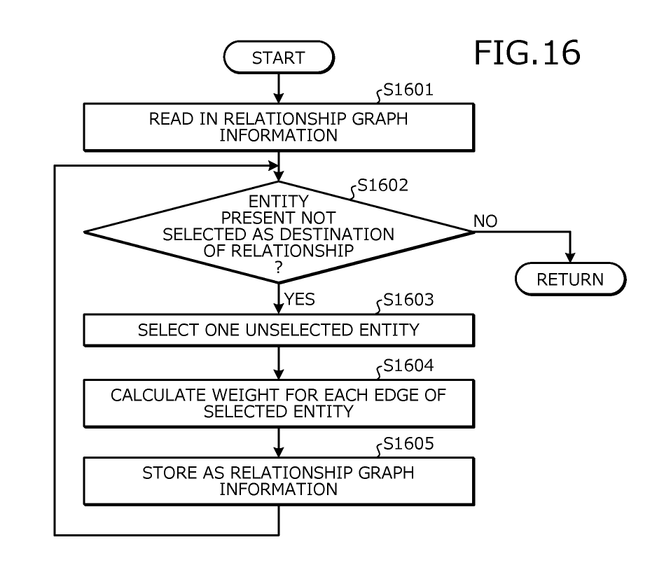

FIG. 14 is a flowchart of one example of the software dividing procedure of the software dividing apparatus 100 according to the first embodiment. In the flowchart of FIG. 14, the software dividing apparatus 100 executes relationship extraction processing (step S1401). The relationship extraction processing is processing of extracting the dependence relationship between the entities as the constituent elements of the software SW. A specific procedure of the relationship extraction processing will be described later with reference to FIG. 15.

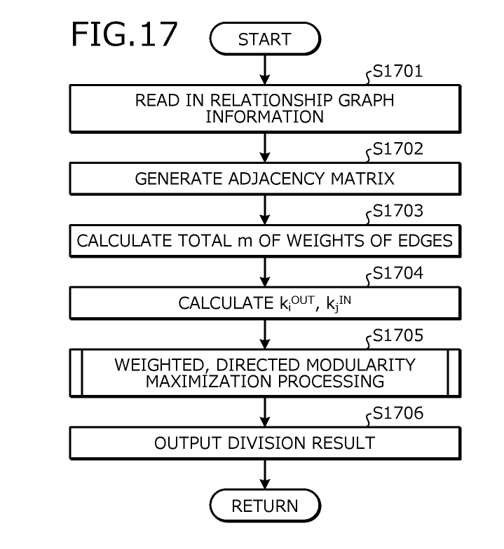

The software dividing apparatus 100 then executes weight calculation processing (step S1402). The weight calculation processing is processing of calculating the weight related to the dependence relationship between the entities. A specific procedure of the weight calculation processing will be described later with reference to FIG. 16.

The software dividing apparatus 100 treats all entities as the constituent elements of the software SW as belonging to one cluster (step S1403). The software dividing apparatus 100 selects the entity set within the cluster that exceeds the upper-limit number of entities as the entity set to be processed (step S1404).

The software dividing apparatus 100 generates new relationship graph information R by extracting the record of the selected entity set to be processed, from the relationship graph information 430 (step S1405).

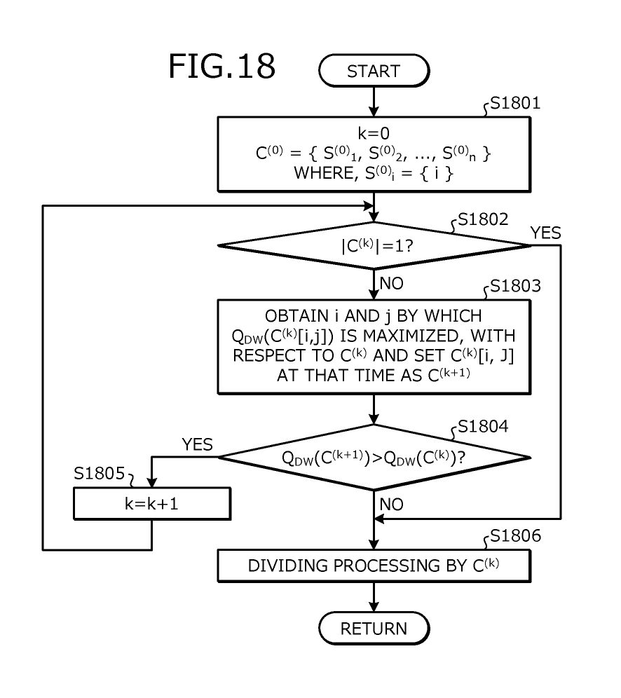

The software dividing apparatus 100 then executes clustering processing, based on the generated new relationship graph information R (step S1406). The clustering processing is processing of dividing the entity set to be processed into plural clusters. A specific procedure of the clustering processing will be described later with reference to FIG. 17.

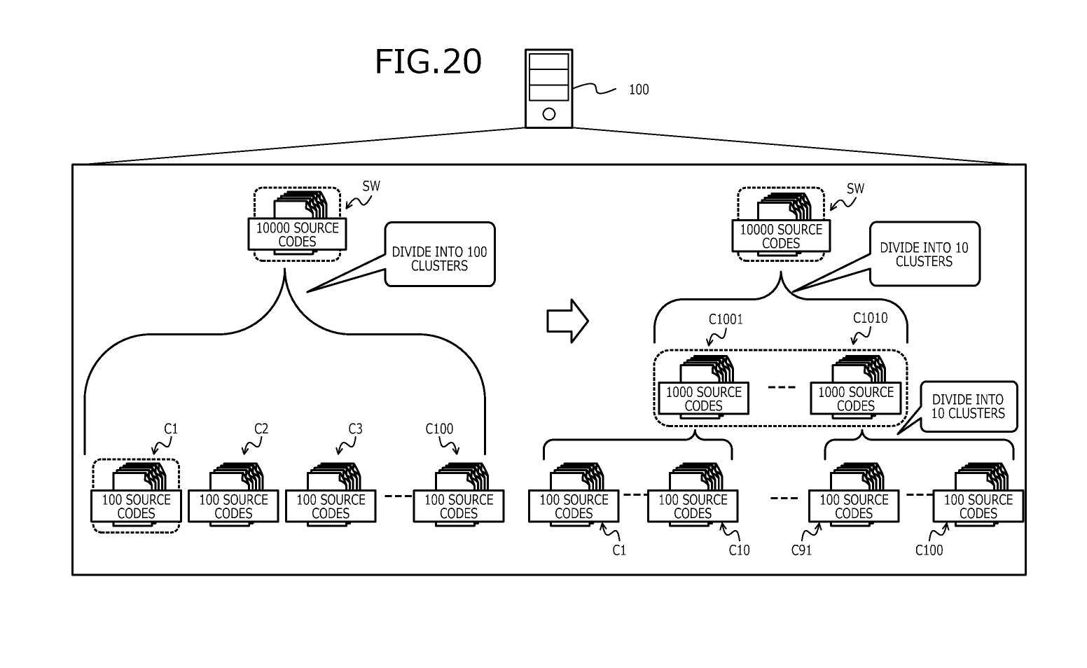

The software dividing apparatus 100 then executes integration processing (step S1407). The integration processing is processing of integrating the division results of the entity set to be processed into the overall division results. A specific procedure of the integration processing will be described later with reference to FIG. 19.

The software dividing apparatus 100 judges if each of the clusters of the lower-most layer satisfies the criteria of the upper-limit number of entities or is impossible to improve (step S1408). If any cluster does not satisfy the criteria of the upper-limit number of entities and if the cluster is not impossible to improve (step S1408: NO), then the software dividing apparatus 100 returns to step S1404.

On the other hand, if each of the clusters of the lower-most layer satisfies the criteria of the upper-limit number of entities or is impossible to improve (step S1408: YES), then the software dividing apparatus 100 outputs the overall division results as the division results 440 (step S1409), completing a sequence of processing according to this flowchart.

This makes it possible to recursively repeat the division of the entity set within the cluster until the number of entities within the cluster obtained by dividing the software SW becomes equal to or smaller than the upper-limit number of entities or becomes impossible to improve.

The specific procedure will be described of the relationship extraction processing depicted at step S1401 of FIG. 14.

FIG. 15 is a flowchart of one example of a specific procedure of the relationship extraction processing. In the flowchart of FIG. 15, the software dividing apparatus 100 reads in the source code of the software SW from the source code DB 410 (step S1501). The software dividing apparatus 100 then analyzes the read-in source code, using the syntax analyzing technology and the static analyzing technology (step S1502).

The software dividing apparatus 100 then extracts the entities from the analyzed source code (step S1503) and at the same time, extracts the dependence relationship between the entities (step S1504). The software dividing apparatus 100 then stores the combination of the source entity of the relationship and the destination entity of the relationship, obtained by the extraction, as the record of the relationship graph information 430 (step S1505), returning to the step at which the relationship extraction processing was called.

This makes it possible to generate the relationship graph information 430. At this point, however, the weight of each record of the relationship graph information 430 is not yet set.

A specific procedure will be described of the weight calculation processing depicted at step S1402 of FIG. 14.

FIG. 16 is a flowchart of one example of a specific procedure of the weight calculation processing. In the flowchart of FIG. 16, the software dividing apparatus 100 reads in the relationship graph information 430 (step S1601) and judges if there is an unselected entity as the destination of the relationship (step S1602).

If there is an unselected entity as the destination of the relationship (step S1602: YES), the software dividing apparatus 100 selects one unselected entity as the destination of the relationship (step S1603). The software dividing apparatus 100 calculates the weight for each edge of the selected entity, using equation (1) above (step S1604).

The software dividing apparatus 100 stores the weight calculated for each edge in the corresponding record of the relationship graph information 430 (step S1605), returning to step S1602. If there is no unselected entity as the destination of the relationship (step S1602: NO), the software dividing apparatus 100 returns to the step at which the weight calculation processing was called.

This makes it possible to generate the relationship graph information 430 with the weight related to the dependence relationship between the entities set.

A specific procedure will be described of the clustering processing depicted at step S1406 of FIG. 14.

FIG. 17 is a flowchart of one example of a specific procedure of the clustering processing. In the flowchart of FIG. 17, the software dividing apparatus 100 reads in the relationship graph information R generated at step S1405 (step S1701) and generates adjacency matrix A (step S1702).

The software dividing apparatus 100 calculates the value of parameter m of the modularity evaluation function Q_{DW} by adding up the weights of the edges as element Aᵢⱼ of adjacency matrix A (step S1703). The software dividing apparatus 100 then calculates parameters kᵢ^{OUT} and kⱼ^{IN} of the modularity evaluation function Q_{DW} (step S1704).

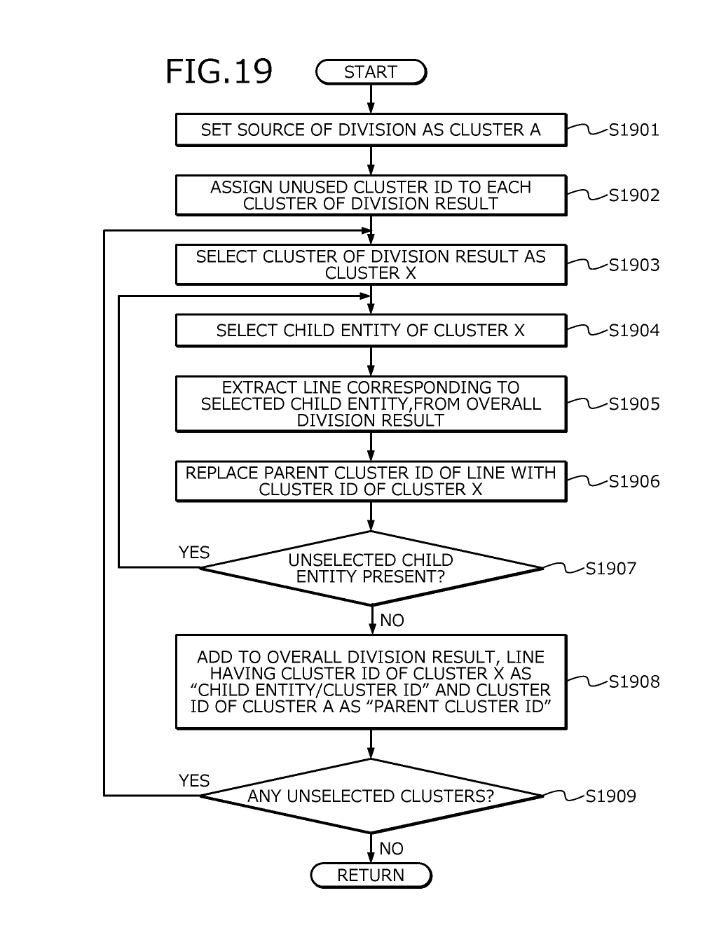

The software dividing apparatus 100 then executes weighted, directed modularity maximization processing (step S1705). The weighted, directed modularity maximization processing is processing of merging the subsets, using the modularity evaluation function Q_{DW}, so that the value of the modularity evaluation function Q_{DW} will be maximized. A specific procedure of the weighted, directed modularity maximization processing will be described later with reference to FIG. 18.

The software dividing apparatus 100 outputs division results obtained by the weighted, directed modularity maximization processing as interim results (step S1706) and returns to the step at which the clustering processing was called. This makes it possible to divide the entity set to be processed into plural clusters.

A specific procedure will be described of the weighted, directed modularity maximization processing depicted at step S1705 of FIG. 17.

FIG. 18 is a flowchart of one example of a specific procedure of the weighted, directed modularity maximization processing. In the flowchart of FIG. 18, the software dividing apparatus 100 sets state k to k=0 and sets partition C^{(k)}=C⁽⁰⁾)={S⁽⁰⁾₁, S⁽⁰⁾₂, . . . , S⁽⁰⁾ₙ} (step S1801). The software dividing apparatus 100 judges if |C^{(k)}|=1 is applicable (step S1802).

If |C^{(k)}|=1 is not applicable (step S1802: NO), then the software dividing apparatus 100 obtains a combination of i and j with which the value of the modularity evaluation function Q_{DW} is maximized, with respect to partition C^{(k+1)} and sets partition C^{(k)} [i, j] at that time as C^{(k+1)} (step S1803).

The software dividing apparatus 100 compares Q_{DW}(C^{(k)}) and Q_{DW}(C^{(k+1)}) (step S1804). If Q_{DW}(C₍ₖ₊₁₎)>Q_{DW}(C^{(k)}) (step S1804: YES), the software dividing apparatus 100, considering that there is margin for increasing Q_{DW} increments k (step S1805) and returns to step S1802. The contents depicted in FIG. 9 correspond to the loop of steps S1802 to S1805.

At step S1802, in the case of |C^{(k)}|=1 (step S1802: YES), since there is no need for further dividing, the software dividing apparatus 100 goes to step S1806. At step S1804, if Q_{DW}(C^{(k+1)})>Q_{DW}(C^{(k)}) is not applicable (step S1804: NO), the software dividing apparatus 100, considering that there is no margin for increasing Q_{DW}, goes to step S1806.

At step S1806, the software dividing apparatus 100 performs dividing processing by partition C^{(k)}(step S1806) and returns to the step at which the weighted, directed modularity maximization processing was called. For example, the software dividing apparatus 100 generates the division results depicted in FIG. 10, using partition C^{(k)}.

This makes it possible to divide the entity set to be processed into plural clusters in such manner that the properties (i) to (iii) above will be satisfied.

A specific procedure will be described of the integration processing depicted at step S1407 of FIG. 14.

FIG. 19 is a flowchart of one example of a specific procedure of the integration processing. In the flowchart of FIG. 19, the software dividing apparatus 100 sets the cluster as a source of division as cluster A (step S1901). The cluster as the source of division is the cluster including the entity set to be processed, selected at step S1404 of FIG. 14, namely, the cluster not satisfying the criteria of the upper-limit number of entities.

The software dividing apparatus 100 assigns an unused the cluster ID to each cluster (subset) of the division results obtained at step S1406 of FIG. 14 (step S1902). The software dividing apparatus 100 then selects an unselected cluster out of the obtained division results as cluster X (step S1903).

The software dividing apparatus 100 selects an unselected child entity out of the child entities of cluster X (step S1904). The child entities of cluster X are the entities as child of cluster X, namely, the entities within cluster X.

The software dividing apparatus 100 extracts the line corresponding to the selected child entity, out of the overall division results (step S1905). The software dividing apparatus 100 then replaces the parent cluster ID of the extracted line with the cluster ID of the cluster X (step S1906).

The software dividing apparatus 100 judges if there is any unselected child entity out of the child entities of cluster X (step S1907). If there is any unselected child entity (step S1907: YES), then the software dividing apparatus 100 returns to step S1904.

On the other hand, if there is no unselected child entity (step S1907: NO), then the software dividing apparatus 100 adds a line having the cluster ID of cluster X as the “child entity/cluster ID” and the cluster ID of cluster A as the “parent cluster ID” to the overall division results (step S1908).

The software dividing apparatus 100 judges if there is any unselected cluster out of the obtained division results (step S1909). If there is any unselected cluster (step S1909: YES), then the software dividing apparatus 100 returns to step S1903.

On the other hand, if there is no unselected cluster (step S1909: NO), then the software dividing apparatus 100 returns to the step at which the integration processing was called. This makes it possible to integrate the division results of the entity set to be processed into the overall division results.

As described above, according to the software dividing apparatus 100 of the first embodiment, according to the selection of the entity set to be processed out of the entity group of the software SW, the entity set to be processed can be divided into plural clusters. In this case, the software dividing apparatus 100 can divide the entity set to be processed so that a total of the weights related to the dependence relationship between the entities within a same cluster will be higher than the expected value of the total, based on the relationship graph information R regarding the entity set to be processed.

This makes it possible to treat the software SW as a set of entities as the constituent elements thereof and divide the software SW or the entity set within the same cluster into plural clusters so that the properties (i) to (iii) above will be satisfied.

According to the software dividing apparatus 100, according to the number of entities within any cluster out of the plural clusters divided exceeding the upper-limit number of entities, the entity set within the cluster can be selected as the entity set to be processed.

This makes it possible to recursively repeat the division of the software, considering the entity set within the cluster as one new software, until the number of entities within the cluster obtained by dividing the software SW becomes equal to or smaller than the upper-limit number of entities. Namely, it is made possible to introduce the hierarchical structure into the division of software SW, dividing the software SW into the subsets of such a small scale that can be understood by a human. Since the division results obtained by using the clustering algorithm having the properties (i) to (iii) above are not arbitrarily processed, the optimum solution of the division results can be prevented from being impaired and the division accuracy can be assured.

According to the software dividing apparatus 100, it is made possible to make arrangement so that, when any entity out of the entity set within a divided cluster is individually called from other entities, the entity set within the cluster will not be selected as the entity set to be processed.

By this, even if the number of entities within a cluster is in excess of the upper-limit number of entities, when the graph structure of the cluster is simple and no further division is necessary, the division of the cluster can be terminated, reducing the processing load on the software dividing apparatus 100.

The software dividing apparatus 100 according to a second embodiment will be described. In the second embodiment, a case will be described of adding a granularity adjusting function of adjusting the number of clusters within a same parent cluster to the software dividing apparatus 100 described in the first embodiment. With respect to portions identical to those described in the first embodiment, illustration and description thereof are omitted.

In the division of the software, the factor making the interpretation by a human difficult is too large a number of clusters into which the software is divided, in addition to too large a number of entities within the cluster described in the first embodiment. For example, in large-scale software with more than several thousand source files, the number of clusters into which the software is divided can be more than 50 and such a number of clusters are difficult to understand for a human.

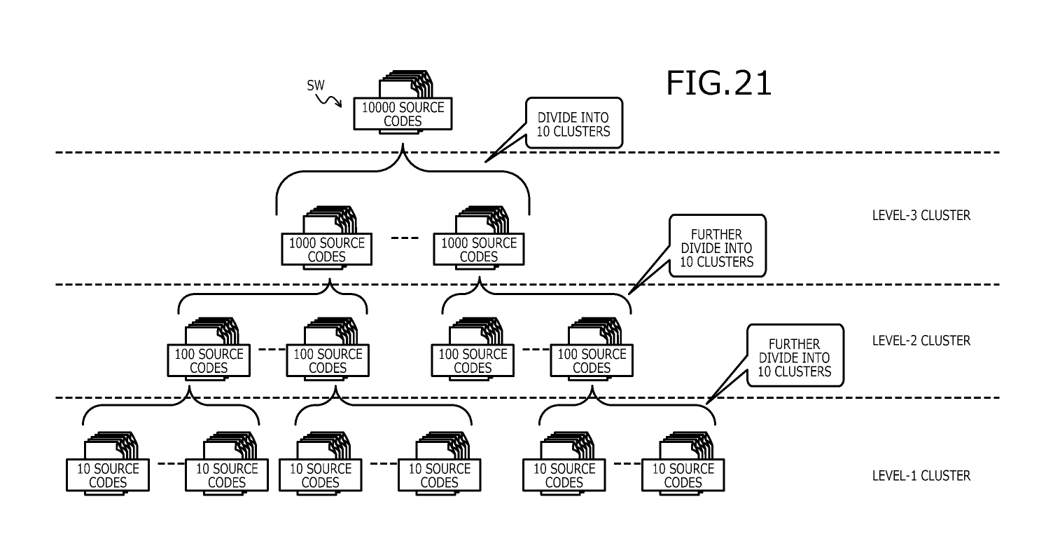

Accordingly, in the second embodiment, the software dividing apparatus 100 introduces granularity adjusting parameter r to adjust the number of clusters (granularity) after the division. The software dividing apparatus 100 repeats the division of the cluster set while changing granularity adjusting parameter r until the number of clusters of the cluster set having a same parent cluster becomes equal to or lower than the predetermined upper-limit number of clusters. By this, the number of clusters having the same parent cluster is reduced to a number of such a level as to be understood by a human. An example will be described of the software division processing of the software dividing apparatus 100 with reference to FIG. 20.

FIG. 20 is an explanatory diagram of an example of the software dividing method according to the second embodiment. The example of FIG. 20 assumes a case in which the software SW (group of 10000 source codes) is divided into 100 clusters C1 to C100. The number of entities (number of source codes) within each of the clusters C1 to C100 is 100.

(1) The software dividing apparatus 100 judges if the number of clusters of the plural clusters into which the software was divided is greater than the pre-stored upper-limit number of clusters. The upper-limit number of clusters is arbitrarily pre-set and is stored in the software dividing apparatus 100. For example, the upper-limit number of clusters is set at such a value that, if exceeded by the number of clusters of the cluster set having a same parent cluster (or the cluster set into which the software is divided), it is difficult for a human to interpret the cluster set, taking into account the skill of a person who analyzes the software.

The example of FIG. 20 assumes a case in which the upper-limit number of clusters is set at “30”. In this case, the software dividing apparatus 100 judges that the number of clusters of the clusters C1 to C100 into which the software SW was divided exceeds the upper-limit number of clusters.

(2) The software dividing apparatus 100, when the number of plural clusters exceeds the upper-limit number of clusters, calculates the weight related to the dependence relationship between the clusters of the plural clusters. The weight related to the dependence relationship between the clusters is identified by the dependence relationship between the entities belonging to the plural clusters and is used as the weight of the edge connecting the clusters as the nodes of the graph.

In the example of FIG. 20, the weight related to the dependence relationship between the clusters of the cluster C1 to C100 is calculated based on the dependence relationship between the entities belonging to the clusters C1 to C100. An example will be described later of the calculation of the weight related to the dependence relationship between the clusters. In the following description, the plural clusters that have the same parent cluster and the number which exceeds the upper-limit number of clusters are sometimes written as “cluster set to be processed”.

(3) The software dividing apparatus 100 divides the cluster set to be processed so that the number of clusters after the division will be reduced, based on the calculated weight related to the dependence relationship between the clusters. For example, the software dividing apparatus 100 introduces granularity adjusting parameter r to adjust the number of clusters (granularity) after the division.

The software dividing apparatus 100 divides the cluster set to be processed so that the number of clusters after the division will be reduced, namely, the number of entities within the cluster after the division will be increased, by adjusting the value of a granularity adjusting parameter r. Details of the granularity adjusting parameter r will be described later.

When, even after the division by setting the granularity adjusting parameter r at a certain value, the number of clusters after the division exceeds the upper-limit number of clusters, the software dividing apparatus 100 re-adjusts granularity adjusting parameter r and re-performs the division so that the number of clusters after the division will become smaller.

Namely, the software dividing apparatus 100 searches for the value of the granularity adjusting parameter r by which the number of clusters after the division becomes equal to or smaller than the upper-limit number of clusters while changing the value of granularity adjusting parameter r. Even by changing the granularity adjusting parameter r, if no further improvement can be made, namely, the number of clusters cannot be reduced any further, the software dividing apparatus 100 terminates the division of the plural clusters.

In the example of FIG. 20, the clusters C1 to C100 are divided into the clusters C1001 to C1010 and the number of clusters into which the software SW is divided is reduced from “100” to “10”. The number of clusters within each of the clusters C1001 to C1010 is “10”. As a result, the number of clusters of the cluster set having a same parent cluster is all equal to or smaller than the upper-limit number of clusters.

Thus, according to the software dividing apparatus 100, it is made possible to repeat the division of the cluster set having a same parent cluster while changing the granularity adjusting parameter r until the number of clusters of such a cluster set becomes equal to or smaller than the upper-limit number of clusters. By this, the number of clusters having a same parent cluster can be reduced to a number of such a level as to enable the understanding by a human.

An example will be described of multi-layer division.

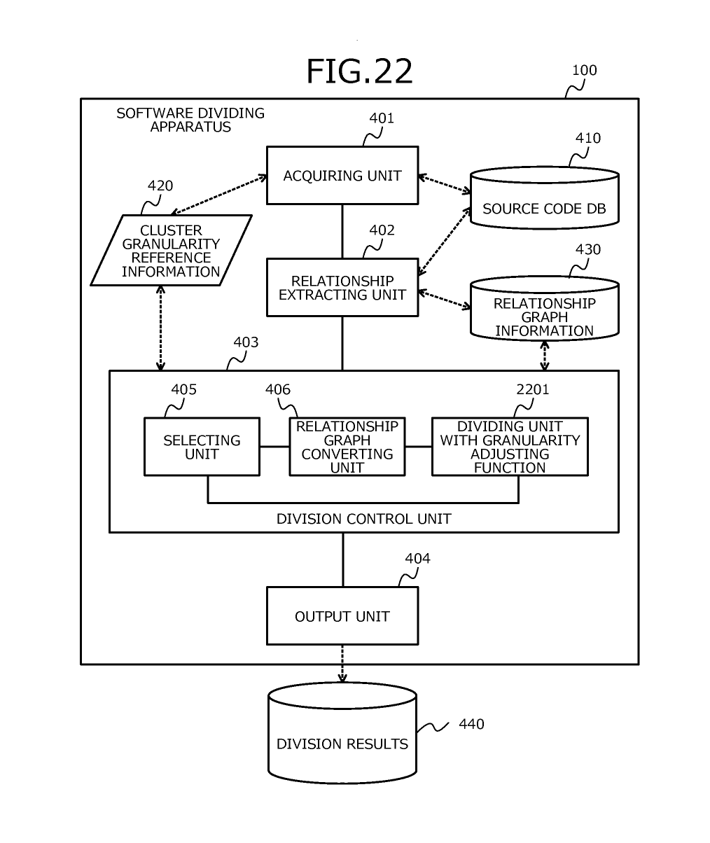

FIG. 21 is an explanatory diagram of the example of multi-layer division. In FIG. 21, the division results of software SW divided by the software dividing apparatus 100 are represented by a three-level hierarchical structure. For example, the software SW is divided into 10 level-3 clusters, each level-3 cluster is divided into 10 level-2 clusters, and each level-2 cluster is divided into 10 level-1 clusters. The number of entities within each level-1 cluster is 10.

When the clusters of each level are seen individually, the number of clusters within a same parent cluster is 10 and is reduced to the number of such a level as to be sufficiently understood by a human. The number of entities within each level-1 cluster at the lower-most layer is 10 and the software is divided into units of such a level as to be sufficiently understood by a human.

A functional configuration example will be described of the software dividing apparatus 100 according to the second embodiment. Functional units will be described that differ from those of the software dividing apparatus 100 according to the first embodiment. Functional units having the same function as that of functional units of the software dividing apparatus 100 according to the first embodiment are given the same reference numerals used in the description of the software dividing apparatus 100 according to the first embodiment.

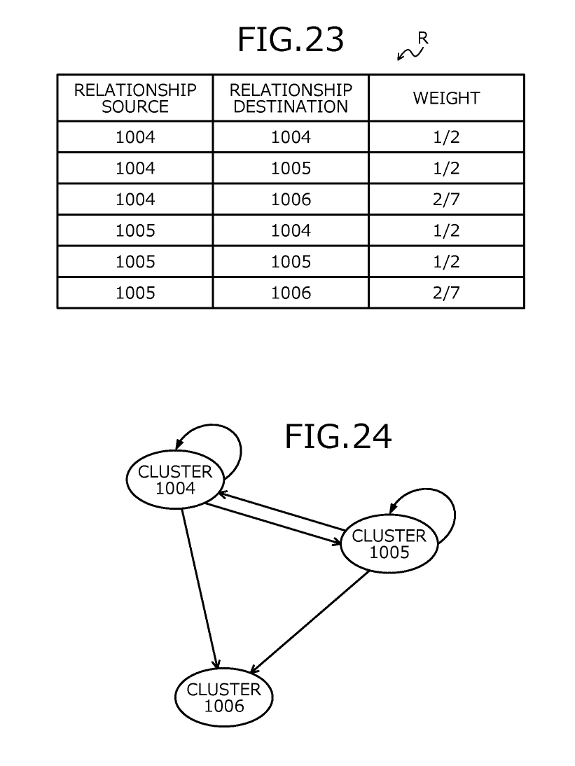

FIG. 22 is a block diagram of a functional configuration example of the software dividing apparatus 100 according to the second embodiment. In FIG. 22, the division control unit 403 has the selecting unit 405, the relationship graph converting unit 406, and a dividing unit with granularity adjusting function 2201.

The selecting unit 405 has a function of selecting the cluster set to be processed. The cluster set to be processed is plural clusters of a number exceeding the upper-limit number of clusters, out of plural clusters obtained by dividing the entity set to be processed.

To describe in more detail, the cluster set to be processed is, for example, a set of subgraphs not satisfying the criteria of the upper-limit number of clusters when the software SW is expressed by a graph and the graph is divided into plural subgraphs. The upper-limit number of clusters is identified, for example, by the cluster granularity reference information 420.

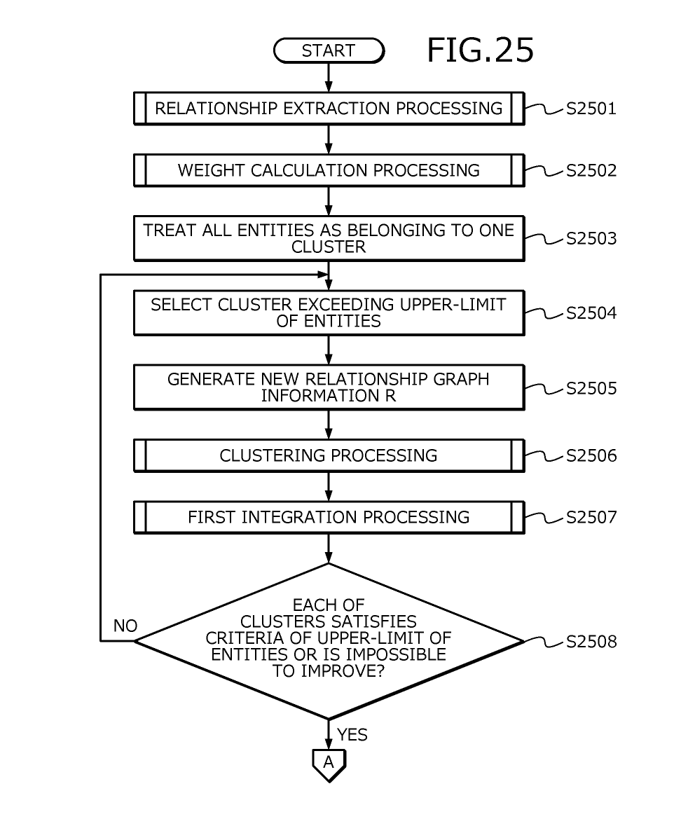

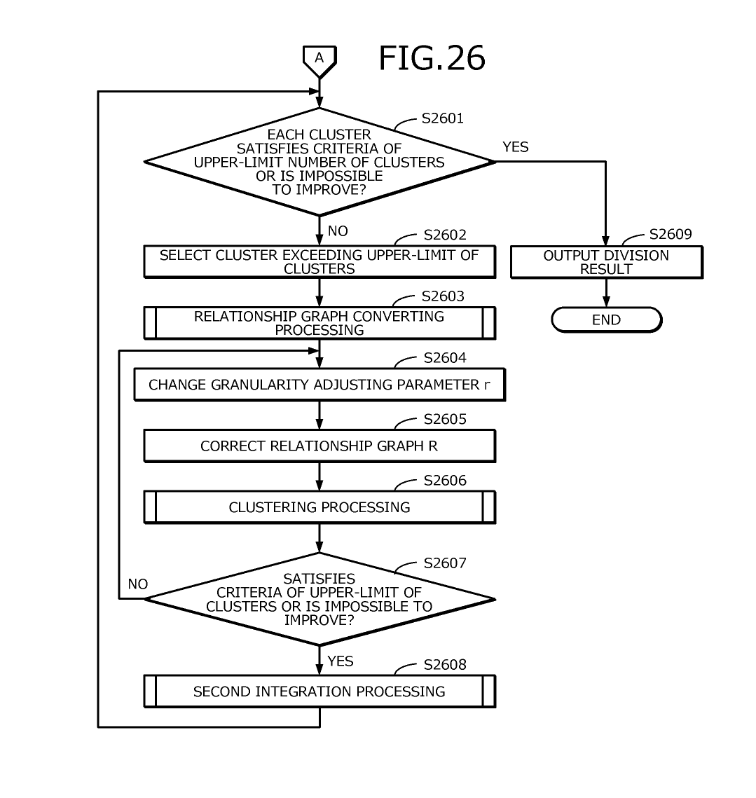

The relationship graph converting unit 406 has a function of calculating the weight related to the dependence relationship between the clusters of the cluster set to be processed, based on the weight related to the dependence relationship between the entities belonging to the cluster set to be processed selected by the selecting unit 405. By this, new relationship graph information R regarding the cluster set to be processed is generated. A generation example will be described later of the relationship graph information R regarding the cluster set to be processed with reference to FIGS. 23 and 24.

The dividing unit with granularity adjusting function 2201 has a function of dividing the cluster set to be processed into plural clusters so that the number of clusters after the division will be reduced, based on the calculated weight related to the dependence relationship between the clusters of the cluster set to be processed. For example, the dividing unit with granularity adjusting function 2201 divides the cluster set to be processed into plural clusters so that the number of clusters after the division will be reduced, by introducing granularity adjusting parameter r to adjust the number of clusters (granularity) after the division.

In this case, the dividing unit with granularity adjusting function 2201 divides the cluster set to be processed into plural clusters so that a total of the weights related to the dependence relationship between the clusters within a same cluster will be higher than the expected value of the total, based on the generated relationship graph information R. Namely, the dividing unit with granularity adjusting function 2201 divides the cluster set to be processed so that the properties (i) to (iii) above will be satisfied. Specific processing contents (first granularity adjusting function and second granularity adjusting function) will be described later of the dividing unit with granularity adjusting function 2201.

While a detailed description is omitted, the dividing unit with granularity adjusting function 2201 has the same function as that of the dividing unit 407 depicted in FIG. 4. Namely, the dividing unit with granularity adjusting function 2201 has a function of dividing the entity set to be processed into plural clusters, according to the selection of the entity set to be processed.

A generation example will be described of the relationship graph information R regarding the cluster set to be processed. A case is assumed in which the upper-limit number of clusters is set at “2” and the clusters 1004 to 1006 having cluster 1003 as the parent cluster depicted in FIG. 12 are selected as the cluster set to be processed. Namely, a case is assumed in which the number of clusters “3” of the clusters 1004 to 1006 exceeds the upper-limit number of clusters.

In this case, the relationship graph converting unit 406 calculates the weight related to the dependence relationship between the clusters of the cluster set {1004, 1005, 1006} to be processed, based on the weight related to the dependence relationship between the entities belonging to the cluster set {1004, 1005, 1006} to be processed.

For example, the relationship graph converting unit 406 generates the relationship graph information R having empty lines. The relationship graph converting unit 406 refers to the division results 1000 depicted in FIG. 13 and identifies set V composed of the clusters having the cluster ID of cluster 1003 as the parent cluster ID. Set V becomes “V={1004, 1005, 1006}”.

The relationship graph converting unit 406 extracts, out of set V, a sequential pair of the clusters and sets the pair as a, b. For example, the relationship graph converting unit 406 extracts, out of set V{1004, 1005, 1006}, “a=1004, b=1005” as the sequential pair a, b.

The relationship graph converting unit 406 defines set X as set {a} having only a as the element. If a cluster is included as the element of set X, then the relationship graph converting unit 406 deletes the element from set X and adds all child entities or child clusters of the element to set X. The relationship graph converting unit 406 repeats this process until there is no cluster remaining in set X.

For example, if a is given as “a=1004” and set X as “X={1004}”, then the relationship graph converting unit 406 refers to the division results 1000 (see FIG. 13), deletes cluster 1004 from set X, and adds all child entities 4 and 13 of cluster 1004 to set X. In this case, set X becomes “X={4, 13}”.

The relationship graph converting unit 406 defines set Y as set {b} having only b as the element. If a cluster is included as the element of set Y, then the relationship graph converting unit 406 deletes the element from set Y and adds all child entities or child clusters of the element to set Y. The relationship graph converting unit 406 repeats this process until there is no cluster remaining in set Y.

For example, if b is given as “b=1005” and set Y as “Y={1005}”, then the relationship graph converting unit 406 refers to the division results 1000 (see FIG. 13), deletes cluster 1005 from set Y and adds all child entities 8 and 12 of cluster 1005 to set Y. In this case, set Y becomes “Y={8, 12}”.

The relationship graph converting unit 406 then extracts lines including set X{4, 13} as the source of the relationship and set Y{8, 12} as the destination of the relationship, from the relationship graph information 430 (see FIG. 8) and calculates a total of the weights of the extracted lines. The total of the weights is given as weight w. If no line is extracted, weight w is given as “w=0”. From the relationship graph information 430 (see FIG. 8), the line is extracted that has “13” as the source of the relationship and “12” as the destination of the relationship and weight w becomes “w=½”.

If weight w is “w>0”, then the relationship graph converting unit 406 adds a line having the cluster ID of a as the source of the relationship, the cluster ID of b as the destination of the relationship, and w as the weight to the relationship graph information R. Thereafter, the relationship graph converting unit 405 repeats the sequence of processes described above until all sequential pairs are extracted from set V.

As a result, the relationship graph information R regarding cluster set {1004, 1005, 1006} is generated. A specific example will be described of the relationship graph information R regarding the cluster set to be processed.

FIG. 23 is an explanatory diagram of a specific example of the relationship graph information R regarding the cluster set to be processed. In FIG. 23, the relationship graph information R indicates the source of the relationship, the destination of the relationship, and the weight, correlated to one another. For example, in the record of the first line of the relationship graph information R, the source of the relationship is “1004” and the destination of the relationship is “1004”. The weight, based on a line having “13” as the source of the relationship and “4” as the destination of the relationship extracted from the relationship graph information 430 (see FIG. 8), becomes “½” as the total of the weights.

FIG. 24 is an explanatory diagram of a graph representation example of the cluster set to be processed. In FIG. 24, an elliptic figure denotes a cluster. Depicted here is a subgraph corresponding to the relationship graph information R depicted in FIG. 23. An arrow between the clusters denotes the dependence relationship. A starting end of the arrow is taken as the cluster as the source of the relationship and a terminating end of the arrow (tip of arrow) is taken as the cluster as the destination of the relationship.

The first granularity adjusting function will be described of the dividing unit with granularity adjusting function 2201. With respect to the first granularity adjusting function, a case will be described of dividing the cluster set to be processed into plural clusters, using an objective function including granularity adjusting parameter r.

For example, the dividing unit with granularity adjusting function 2201 divides the cluster set to be processed into plural clusters, using equation (9). Equation (9) is an extension of the objective function whose value increases when a desirable entity is contained within the cluster and decreases when an undesirable entity is contained within the cluster.

f_{g}(G(C),P(C),r)=G(C)−r·P(C) (9)

In equation (9) above, C denotes partition. G(C) denotes a gain whose value increases when the desirable entity is contained within the cluster. P(C) denotes a penalty whose value increases when the undesirable entity is contained within the cluster. r denotes a non-negative, real-number granularity adjusting parameter. The initial value of granularity adjusting parameter r is arbitrarily settable and is, for example, “1”.

G(C) of equation (9) above is given as equation (10) and P(C) of equation (9) above is given as equation (11).

$$\begin{matrix}G ( C ) = \frac{1}{m} {\sum }_{i , j} {A}_{ij} δ ( {c}_{i} , {c}_{j} ) & ( 10 ) \\ P ( C ) = \frac{1}{m} {\sum }_{i , j} \frac{{k}_{i}^{OUT} {k}_{j}^{IN}}{m} δ ( {c}_{i} , {c}_{j} ) & ( 11 )\end{matrix}$$

In this case, equation (2) above becomes “Q_{DW}(C)=G(C)−P(C)” and if this is expressed as f(G(C), P(C)), then equation (9) above is introduced. Namely, equation (9) above is the equation obtained by replacing the objective function Q_{DW} by the objective function f_{g}(G(C), P(C), r) having granularity adjusting parameter r.

Equation (9) above has a feature that when the contribution to the penalty P(C) increases by increasing the value of granularity adjusting parameter r from 1, it becomes more difficult to keep the entities within the cluster, the number of entities within the cluster decreases, and the number of clusters increases. On the other hand, equation (9) above has a feature that when the contribution to the penalty P(C) decreases by decreasing the value of granularity adjusting parameter r from 1, it becomes easier to keep the entities within the cluster, the number of entities within the cluster increases, and the number of clusters decreases.

The dividing unit with granularity adjusting function 2201 changes the value of granularity adjusting parameter r included in equation (9) above so that the contribution to the penalty P(C) will decrease. For example, the dividing unit with granularity adjusting function 2201 causes granularity adjusting parameter r to be decreased by a preset decrease value. The decrease value is arbitrarily settable and is, for example, “0.1”.

The dividing unit with granularity adjusting function 2201 divides the cluster set to be processed into plural clusters so that equation (9) above with the value of granularity adjusting parameter r changed will be maximized, based on the relationship graph information R regarding the cluster set to be processed. In this case, the dividing unit with granularity adjusting function 2201 treats each cluster of the cluster set to be processed in the same manner as each entity of the entity set to be processed is treated.

When, as a result of the division of the cluster set to be processed, the number of clusters exceeds the upper-limit number of clusters, the dividing unit with granularity adjusting function 2201 again changes the value of granularity adjusting parameter r and repeats the division of the cluster set to be processed.

Even by the adjustment of the value of granularity adjusting parameter r, when no further improvement can be made, namely, the number of clusters cannot be decreased any further, the dividing unit with granularity adjusting function 2201 terminates the division of the cluster set to be processed. For example, the dividing unit with granularity adjusting function 2201 may terminate the division of the cluster set to be processed when the value of granularity adjusting parameter r exceeds a preset upper-limit value, considering that no further improvement is possible. The upper limit value is arbitrarily settable and is, for example, “10”.

While a case has been described of seeking granularity adjusting parameter r by the linear search, the search method is not limited to this. For example, the dividing unit with granularity adjusting function 2201 may seek granularity adjusting parameter r, using other search methods such as the binary searching in the range from the initial value to the lower-limit value of the granularity adjusting parameter r.

The second granularity adjusting function will be described of the dividing unit with granularity adjusting function 2201. With respect to the second granularity adjusting function, a case will be described of correcting the relationship graph information R regarding the cluster set to be processed, using granularity adjusting parameter r, and dividing the cluster set to be processed into plural clusters, based on the relationship graph information R after the correction.

The dividing unit with granularity adjusting function 2201 corrects the weight related to the dependence relationship between the clusters of the cluster set to be processed so that the weight related to the dependence relationship between a same cluster will be relatively decreased. For example, the dividing unit with granularity adjusting function 2201 applies a correction of multiplying the weight of a self-loop edge (edge going out of a certain node and returning to the same node) by granularity adjusting parameter r, to the relationship graph information R related to the cluster set to be processed.

Granularity adjusting parameter r is a non-negative real number. The initial value of granularity adjusting parameter r is arbitrarily settable and is, for example, “1”. If granularity adjusting parameter r is decreased by a certain decrease value from the initial value, the weight of the self-loop edge is decreased. The decrease value is arbitrarily settable and is, for example, “0.1”.

Since the self-loop edge is included within the cluster, the weight of the edge connecting different clusters becomes relatively large. For this reason, plural child clusters are more easily kept within the cluster after the division and the number of clusters after the division is decreased. In this case, the dividing unit with granularity adjusting function 2201 does not correct the weight of the edge other than the self-loop edge.

When the relationship graph information R depicted in FIG. 23 is cited by way of example, the dividing unit with granularity adjusting function 2201 multiplies the weight of the line having the same cluster ID for the source of the relationship and the destination of the relationship by granularity adjusting parameter r. For example, it is assumed that the granularity adjusting parameter r is “0.9” after the initial value “1” is decreased by the decrease value “0.1”.

In this case, the dividing unit with granularity adjusting function 2201 multiplies the weight “½” of the first line having the same cluster ID for the source of relationship and the destination of the relationship of the relationship graph information R by “r=0.9”. The dividing unit with granularity adjusting function 2201 multiplies the weight “½” of the fifth line having the same cluster ID for the source of relationship and the destination of the relationship of the relationship graph information R by “r=0.9”.

The dividing unit with granularity adjusting function 2201 divides the cluster set to be processed into plural clusters so that equation (2) above will be maximized, based on the relationship graph information R after the correction. In this case, the dividing unit with granularity adjusting function 2201 treats each cluster of the cluster set to be processed in the same manner as each entity of the entity set to be processed is treated.

When, as a result of the division of the cluster set to be processed, the number of clusters exceeds the upper-limit number of clusters, the dividing unit with granularity adjusting function 2201 again changes the value of granularity adjusting parameter r and performs the division of the cluster set to be processed all over again.

Even by the adjustment of the value of granularity adjusting parameter r, when no further improvement can be made, namely, the criteria of the upper-limit number of clusters cannot be satisfied, however, the dividing unit with granularity adjusting function 2201 terminates the division of the cluster set to be processed. For example, the dividing unit with granularity adjusting function 2201 may terminate the division of the cluster set to be processed when the value of granularity adjusting parameter r becomes equal to or smaller than a preset lower-limit value, considering that no further improvement is possible. The lower-limit value is arbitrarily settable and is, for example, “0”.

While a case has been described of seeking granularity adjusting parameter r by the linear search, the search method is not limited to this. For example, the dividing unit with granularity adjusting function 2201 may seek granularity adjusting parameter r, using other search methods such as a binary search in the range from the initial value to the lower-limit value of granularity adjusting parameter r.

The dividing unit with granularity adjusting function 2201 may divide the cluster set to be processed into plural clusters, using equation (9) above in place of equation (2) above. In this case, however, the value of granularity adjusting parameter r included in equation (9) above is to be a fixed value (e.g., 1).

The software dividing procedure will be described of the software dividing apparatus 100 according to the second embodiment. Description will be made taking a case of dividing the cluster set to be processed into plural clusters, using the second granularity adjusting function of the dividing unit with granularity adjusting function 2201 described above.

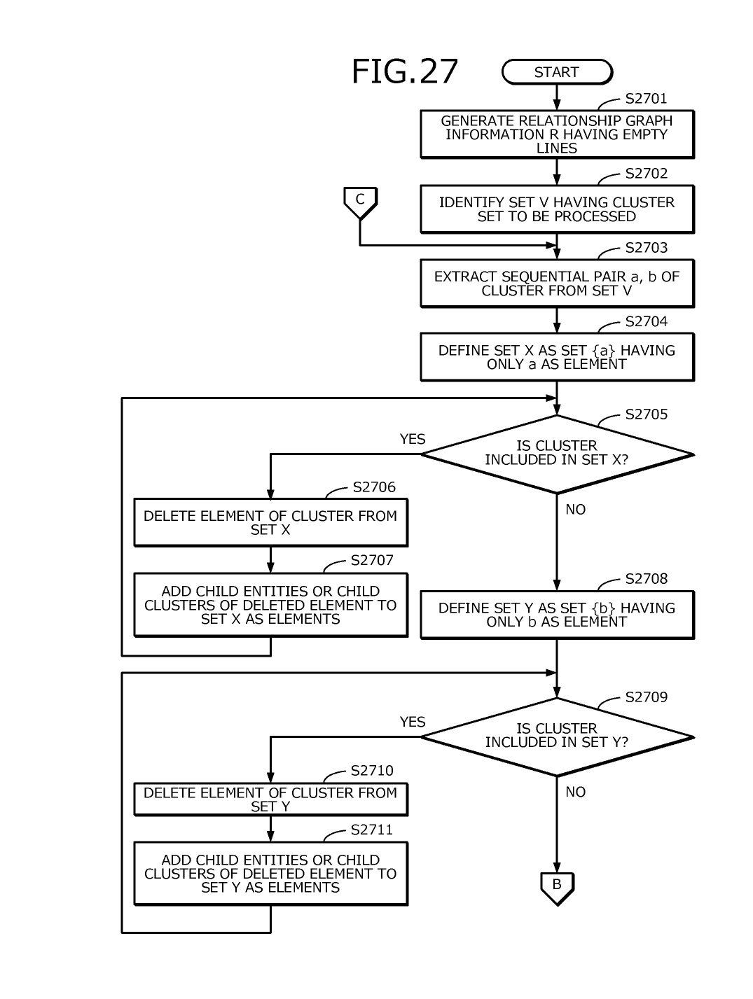

FIGS. 25 and 26 is a flowchart of one example of the software dividing procedure of the software dividing apparatus 100 according to the second embodiment. In the flowchart of FIG. 25, the software dividing apparatus 100 executes relationship extraction processing (step S2501). The relationship extraction processing is processing of extracting the dependence relationship between the entities as the constituent elements of the software SW. A specific procedure of the relationship extraction processing is the same as that described with reference to FIG. 15 and therefore, description thereof is omitted herein.

The software dividing apparatus 100 then executes weight calculation processing (step S2502). A specific procedure of the weight calculation processing is the same as that described with reference to FIG. 16 and therefore, description thereof is omitted herein.

The software dividing apparatus 100 treats all entities as the constituent elements of the software SW as belonging to one cluster (step S2503). The software dividing apparatus 100 selects the entity set within the cluster that exceeds the upper-limit number of entities as the entity set to be processed (step S2504).

The software dividing apparatus 100 generates new relationship graph information R by extracting the record of the selected entity set to be processed, from the relationship graph information 430 (step S2505).

The software dividing apparatus 100 then executes clustering processing, based on the generated new relationship graph information R (step S2506). A specific procedure of the clustering processing is the same as that described with reference to FIG. 17 and therefore, description thereof is omitted herein.

The software dividing apparatus 100 then executes first integration processing (step S2507). The first integration processing is processing of integrating the division results of the entity set to be processed into the overall division results. A specific procedure of the first integration processing is the same as that described with reference to FIG. 19 and therefore, description thereof is omitted herein.

The software dividing apparatus 100 judges if each of the clusters of the lower-most layer satisfies the criteria of the upper-limit number of entities or is impossible to improve (step S2508). If any cluster does not satisfy the criteria of the upper-limit number of entities and if the cluster is not impossible to improve (step S2508: NO), then the software dividing apparatus 100 returns to step S2504.

On the other hand, if each of the clusters of the lower-most layer satisfies the criteria of the upper-limit number of entities or is impossible to improve (step S2508: YES), the software dividing apparatus 100 goes to step S2601 depicted in FIG. 26.

In the flowchart of FIG. 26, the software dividing apparatus 100 judges if each cluster satisfies the criteria of the upper-limit number of clusters or is impossible to improve (step S2601).

If any cluster does not satisfy the criteria of the upper-limit number of clusters and if the cluster is not impossible to improve (step S2601: NO), the software dividing apparatus 100 selects the cluster set within the cluster exceeding the upper-limit number of clusters as the cluster set to be processed (step S2602).

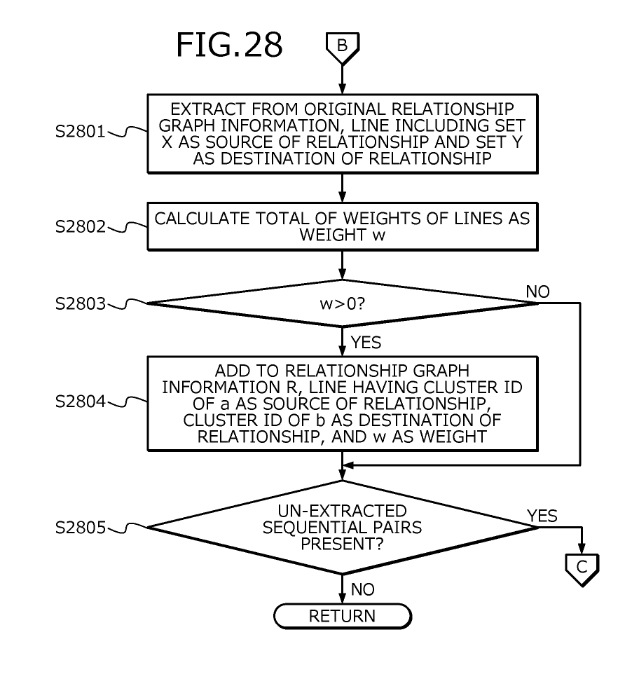

The software dividing apparatus 100 executes relationship graph converting processing (step S2603). The relationship graph converting processing is processing of generating new relationship graph information R regarding the cluster set to be processed. A specific procedure will be described later of the relationship converting processing with reference to FIGS. 27 and 28.

The software dividing apparatus 100 changes granularity adjusting parameter r (step S2604). For example, the software dividing apparatus 100 changes granularity adjusting parameter r by subtracting the preset decrease value (e.g., 0.1) from the granularity adjusting parameter r. The initial value of the granularity adjusting parameter r is, for example, “1”.

The software dividing apparatus 100 corrects the relationship graph information R regarding the cluster set to be processed by multiplying the weight of the self-loop edge by the granularity adjusting parameter r (step S2605).

The software dividing apparatus 100 then executes the clustering processing of dividing the cluster set to be processed into plural clusters, based on the relationship graph information R after the correction (step S2606). Since the specific procedure of the clustering processing is the same as that of the clustering processing depicted in FIG. 17, description thereof is omitted.

The software dividing apparatus 100 judges if the number of clusters obtained by the division satisfies the criteria of the upper-limit number of clusters or is impossible to improve (step S2607). If the number of clusters does not satisfy the criteria of the upper-limit number of clusters and if the number of clusters is not impossible to improve (step S2607: NO), the software dividing apparatus 100 returns to step S2604.

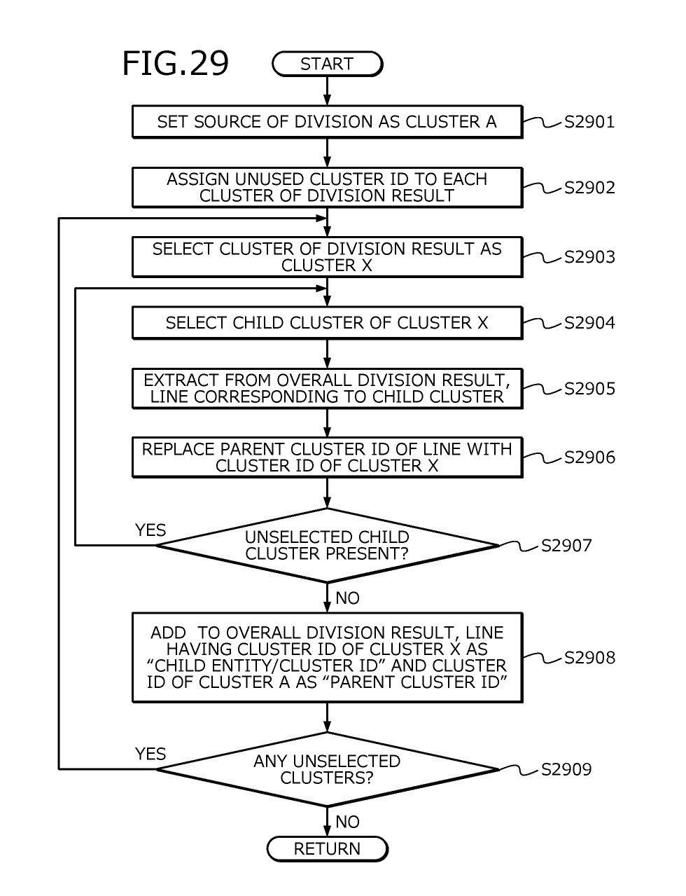

On the other hand, if the number of clusters satisfies the criteria of the upper-limit number of clusters or is impossible to improve (step S2607: YES), the software dividing apparatus 100 executes second integration processing (step S2608) and returns to step S2601. The second integration processing is processing of integrating the division results of the cluster set to be processed into the overall division results. A specific procedure will be described later of the second integration processing with reference to FIG. 29.

At step S2601, if each cluster satisfies the criteria of the upper-limit number of clusters or is impossible to improve (step S2601: YES), then the software dividing apparatus 100 outputs the overall division results as the division results 440 (step S2609), completing a sequence of processing according to this flowchart.

This makes it possible to recursively repeat the division of the entity set within the cluster until the number of entities within the cluster obtained by the division of the software SW becomes equal to or smaller than the upper-limit number of entities or becomes impossible to improve. It is made possible to repeat the division of the cluster set having a same parent cluster while changing the granularity adjusting parameter r until the number of clusters of such a cluster set becomes equal to or smaller than the upper-limit number of clusters or becomes impossible to improve.

A specific procedure will be described of the relationship graph converting processing depicted at step S2603 of FIG. 26.

FIGS. 27 and 28 are a flowchart of one example of a specific procedure of the relationship graph converting processing. In the flowchart of FIG. 27, the software dividing apparatus 100 generates the relationship graph information R having empty lines (step S2701). The software dividing apparatus 100 identifies set V having the cluster set to be processed (step S2702).

The software dividing apparatus 100 then extracts sequential pair a, b of the cluster from set V (step S2703). The software dividing apparatus 100 defines set X as set {a} having only a as the element (step S2704) and judges if a cluster is included as the element of set X (step S2705).

If a cluster is included as the element of set X (step S2705: YES), then the software dividing apparatus 100 deletes the element of the cluster from set X (step S2706). The software dividing apparatus 100 then adds all child entities or child clusters of the deleted element to set X as its elements (step S2707), returning to step S2705.

At step S2705, if no cluster is included as the element of set X (step S2705: NO), the software dividing apparatus 100 defines set Y as set {b} having only b as the element (step S2708) and judges if a cluster is included as the element of set Y (step S2709).

If a cluster is included as the element of set Y (step S2709: YES), the software dividing apparatus 100 deletes the element of the cluster from set Y (step S2710). The software dividing apparatus 100 adds all child entities or child clusters of the deleted element to set Y as its elements (step S2711), and returns to step S2709.

At step S2709, if no cluster is included as the element of set Y (step S2709: NO), the software dividing apparatus 100 goes to step S2801 depicted in FIG. 28.

In the flowchart of FIG. 28, the software dividing apparatus 100 extracts lines including set X as the source of the relationship and set Y as the destination of the relationship, from the original relationship graph information 430 (see FIG. 8) (step S2801). The software dividing apparatus 100 calculates weight w by calculating a total of the weights of the extracted lines as weight w (step S2802). If no line was extracted, the software dividing apparatus 100 sets weight w at “w=0”.

The software dividing apparatus 100 then judges if the calculated weight w is larger than “0” (step S2803). If weight w is equal to or smaller than “0” (step S2803: NO), then the software dividing apparatus 100 goes to step S2805.

On the other hand, if weight w is larger than “0” (step S2803: YES), then the software dividing apparatus 100 adds a line having the cluster ID of a as the source of the relationship, the cluster ID of b as the destination of the relationship, and w as the weight, to the relationship graph information R (step S2804). The software dividing apparatus 100 then judges if there is any un-extracted sequential pair of the cluster, not yet extracted from set V (step S2805).

If there is any un-extracted sequential pair of the clusters (step S2805: YES), the software dividing apparatus 100 returns to step S2703 depicted in FIG. 27. On the other hand, if there is no un-extracted sequential pair of the clusters (step S2805: NO), the software dividing apparatus 100 returns to the step at which the relationship graph converting processing was called.

This makes it possible to generate the relationship graph information R regarding the cluster set to be processed.

A specific procedure will be described of the second integration processing depicted at step S2608 of FIG. 26.

FIG. 29 is a flowchart of one example of a specific procedure of the second integration processing. In the flowchart of FIG. 29, the software dividing apparatus 100 sets a cluster as the source of division as cluster A (step S2901). The cluster as the source of division is the cluster including the cluster set to be processed, selected at step S2602 of FIG. 26, namely, the cluster not satisfying the criteria of the upper-limit number of clusters.

The software dividing apparatus 100 assigns the cluster ID unused overall to each cluster (subset) of the division results obtained at step S2606 of FIG. 26 (step S2902). The software dividing apparatus 100 selects an unselected cluster out of the obtained division results as cluster X (step S2903).

The software dividing apparatus 100 selects an unselected child cluster out of the child clusters of cluster X (step S2904). The child clusters of cluster X are clusters as children of cluster X, namely, the clusters within cluster X.

The software dividing apparatus 100 extracts a corresponding line of the selected child cluster out of the overall division results (step S2905). The software dividing apparatus 100 replaces the parent cluster ID of the extracted line with the cluster ID of cluster X (step S2906).

The software dividing apparatus 100 judges if there is any unselected child cluster not yet selected out of the child clusters of cluster X (step S2907). If there is any unselected child cluster (step S2907: YES), the software dividing apparatus 100 returns to step S2904.

On the other hand, If there is no unselected child cluster (step S2907: NO), the software dividing apparatus 100 adds a line having the cluster ID of cluster X as the “child entity/cluster ID” and the cluster ID of cluster A as the “parent cluster ID” to the overall division results (step S2908).

The software dividing apparatus 100 judges if there is any unselected cluster not yet selected out of the obtained division results (step S2909). If there is any unselected cluster (step S2909: YES), the software dividing apparatus 100 returns to step S2903.

On the other hand, if there is no unselected cluster (step S2909: NO), the software dividing apparatus 100 returns to the step at which the second integration processing was called. This makes it possible to integrate the division results of the cluster set to be processed into the overall division results.

While the above description has been made taking a case of using the second granularity adjusting function of the dividing unit with granularity adjusting function 2201, the first granularity adjusting function may be used of the dividing unit with granularity adjusting function 2201. In this case, for example, at step S2604 depicted in FIG. 26, the software dividing apparatus 100 changes the granularity adjusting parameter r by subtracting the decrease value (e.g., 0.1) from the granularity adjusting parameter r. The initial value of the granularity adjusting parameter r is, for example, “1”. The software dividing apparatus 100 does not perform the correction of the relationship graph information R at step S2605.

At step S2606, the software dividing apparatus 100 performs the clustering processing, using equation (9) above in place of equation (2) above. For this reason, in the weighted, directed modularity maximization processing depicted in FIG. 18, the evaluation is performed of the objective function f_{g} in place of the modularity evaluation function Q_{DW}.

As described above, according to the software dividing apparatus 100 of the second embodiment, according to the number of plural clusters having a same parent cluster exceeding the upper-limit number of clusters, the plural clusters can be selected as the cluster set to be processed. According to the software dividing apparatus 100, the weight related to the dependence relationship between the clusters of the cluster set to be processed can be calculated based on the weight related to the dependence relationship between the entities belonging to the cluster set to be processed. This makes it possible to generate the relationship graph information R regarding the cluster set to be processed.

According to the software dividing apparatus 100, the cluster set to be processed can be divided into plural clusters so that the number of clusters after the division will be reduced. In this case, the software dividing apparatus 100 can divide the cluster set to be processed so that a total of the weights related to the dependence relationship between the clusters, within the same cluster will be higher than the expected value of the total, based on the relationship graph information R regarding the cluster set to be processed.

This makes it possible to treat the clusters whose number of clusters exceeds the upper-limit number of clusters as a set of child clusters thereof and divide the set of the child clusters into plural clusters so that the properties (i) to (iii) described above will be satisfied and that the number of clusters after the division will be reduced.

For example, according to the software dividing apparatus 100, the value of granularity adjusting parameter r included in equation (9) above can be changed so that the contribution to penalty P(C) will be decreased. According to the software dividing apparatus 100, the cluster set to be processed can be divided so that equation (9) above including the changed granularity adjusting parameter r will be maximized, based on the relationship graph information R regarding the cluster set to be processed.

This makes it possible to repeat the division of the cluster set to be processed while changing the granularity adjusting parameter r included in equation (9) above until the number of clusters of the cluster set to be processed becomes equal to or smaller than the upper-limit number of clusters. As a result, the number of clusters of the cluster set having the same parent cluster can be reduced to a number of such a level as to enable a human to understand the relationship between the clusters.

For example, according to the software dividing apparatus 100, the relationship graph information R can be corrected so that the weight related to the dependence relationship between a same cluster will be relatively decreased, by multiplying the weight related to the dependence relationship between a same cluster out of the cluster set to be processed by granularity adjusting parameter r. According to the software dividing apparatus 100, the cluster set to be processed can be divided so that equation (2) above will be maximized, based on the corrected relationship graph information R.

This makes it possible to repeat the division of the cluster set to be processed while changing the granularity adjusting parameter r by which the weight related to the dependence relationship between a same cluster is multiplied, until the number of clusters of the cluster set to be processed becomes equal to or smaller than the upper-limit number of clusters. As a result, the number of clusters of the cluster set having the same parent cluster can be reduced to the number of such a level as to enable a human to understand the relationship between the clusters.

From these matters, according to the software dividing apparatus 100, even if large scale software having more than several thousand source files is processed, the software can be divided into units of such a small scale as to be understood intuitively and easily by a human. This makes it possible to determine, with low costs and low man-hours, the range of the software to be taken out as a reusable software component for the purpose of, for example, software rebuilding and web servicing. It is made possible to determine, with low cost and low man-hours, the unit by which the man-hour is assigned for the software development/maintenance or the unit by which quality control of the software is performed.

An actual example will be described of a case of dividing open source software having more than 2000 source files (classes) by the software dividing apparatus 100. The upper-limit number of clusters is set at “30” and the upper-limit number of entities at “50”.

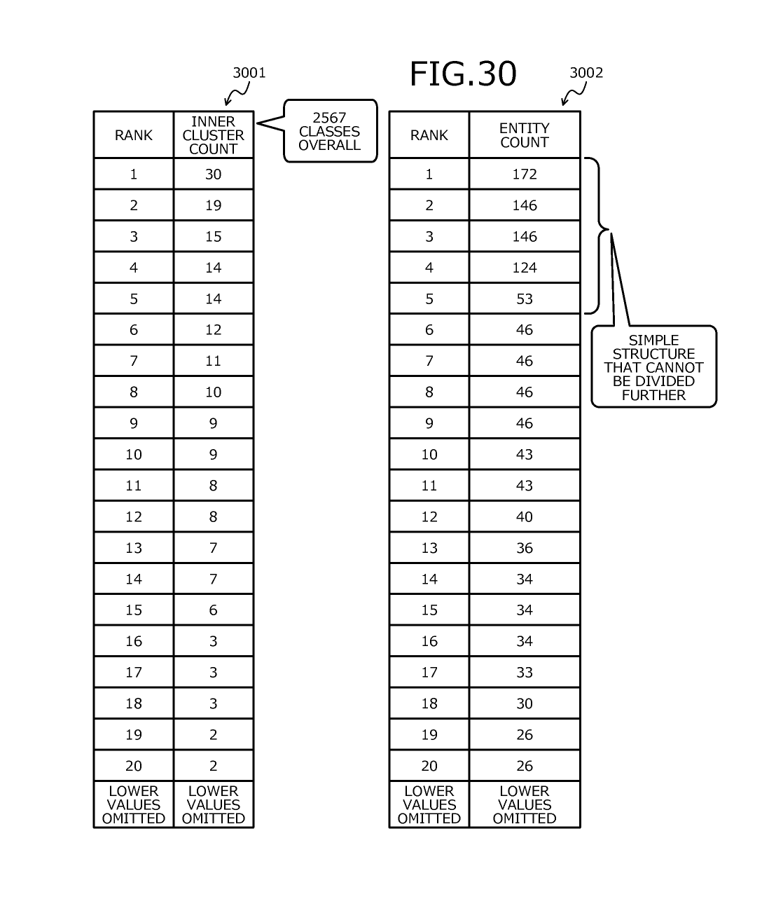

FIG. 30 is an explanatory diagram of a software division example. In FIG. 30, table 3001 depicts the clusters into which the open source software is divided, in descending order of the number of inner clusters. The number of inner clusters is the number of clusters having the same parent cluster. FIG. 30, however, depicts an extraction of the top 20 clusters in the number of inner clusters, out of the plural clusters into which the open source software is divided.

According to table 3001, while the total number of clusters is as large as 196, the number of clusters within one cluster is equal to or smaller than the upper-limit number of clusters of 30 and this demonstrates that the open source software is divided to such an extent as to enable the human to easily understand the relationship between the clusters.

Table 3002 depicts the lowermost-layer clusters, in descending order of the number of inner entities, out of the plural clusters into which the open source software is divided. The number of inner entities is the number of entities within the cluster. FIG. 30, however, illustrates an extraction of the top 20 clusters in the number of inner entities, out of the lowermost-layer clusters.

Table 3002 demonstrates that the number of entities within one cluster is almost equal to or smaller than the upper-limit number of entities of 50. The top 5 clusters are of a simple structure incapable of any further division. This demonstrates that the open source software is divided to such an extent as to enable a human to easily understand the relationship between the entities within the cluster.

The software dividing method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiments, software can be divided into manageable units.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a software dividing program that causes a computer to execute a process comprising:
dividing a target entity set into a plurality of clusters, the target entity set being divided according to a selection of the target entity set to be processed among an entity group as a constituent element group of software, the target entity set being divided based on a weight that is related to a dependence relationship between entities of the entity group and identified by the dependence relationship, the target entity set being divided so that a total of the weights related to the dependence relationships between the entities within a same cluster will be higher than an expected value of the total; and
selecting, when a count of entities within a cluster among the divided plurality of clusters exceeds a pre-stored upper-limit number of entities, an entity set within the cluster as the target entity set.

2. The recording medium according to claim 1, the process further comprising:
calculating, when a cluster count of the divided plurality of clusters exceeds a pre-stored upper-limit number of clusters, a weight related to a dependence relationship between the clusters of the plurality of clusters, based on the weight related to the dependence relationship between the entities belonging to the plurality of clusters; and
dividing the plurality of clusters into a plurality of clusters so as to cause a total of the weights related to the dependence relationships between the clusters within a same cluster to become higher than an expected value of the total, the plurality of clusters being divided based on the calculated weight related to the dependence relationship between the clusters of the plurality of clusters, so that the number of clusters after the division will be smaller than the number of clusters before the division.

3. The recording medium according to claim 2, the process further comprising:
changing a value of a parameter contributing to a penalty that decreases a value of an objective function that becomes high when the total of the weights related to the dependence relationships between the clusters within the same cluster is higher than the expected value of the total, the value of the parameter being included in the objective function and changed so that the contribution to the penalty will decrease, wherein
the dividing of the plurality of clusters includes dividing the plurality of clusters into a plurality of clusters so that the objective function that includes the changed value of the parameter will be maximized, based on the weight related to the dependence relationship between the clusters of the plurality of clusters.

4. The recording medium according to claim 2, the process further comprising:
correcting the calculated weight related to the dependence relationship between the clusters of the plurality of clusters so that the weight related to the dependence relationship between the same cluster among the plurality of clusters will decrease relatively, wherein
the dividing of the plurality of clusters includes dividing, based on the corrected weight related to the dependence relationship between the clusters of the plurality of clusters, the plurality of clusters into a plurality of clusters so that the total of the weights related to the dependence relationships between the clusters within the same cluster will be higher than the expected value of the total.

5. The recording medium according to claim 1, wherein
the selecting of the target entity set includes not selecting the entity set within the cluster as the target entity set when an entity among the entity set within the cluster is called from other entities individually.

6. A software dividing apparatus comprising:
a processor that:
divides a target entity set into a plurality of clusters, the target entity set being divided according to a selection of the target entity set to be processed among an entity group as a constituent element group of software, the target entity set being divided based on a weight that is related to a dependence relationship between entities of the entity group and identified by the dependence relationship, the target entity set being divided so that a total of the weights related to the dependence relationships between the entities within a same cluster will be higher than an expected value of the total; and
selects, when a count of entities within a cluster among the divided plurality of clusters exceeds a pre-stored upper-limit number of entities, an entity set within the cluster as the target entity set.

7. A software dividing method comprising:
dividing, by a processor, a target entity set into a plurality of clusters, the target entity set being divided according to a selection of the target entity set to be processed among an entity group as a constituent element group of software, the target entity set being divided based on a weight that is related to a dependence relationship between entities of the entity group and identified by the dependence relationship, the target entity set being divided so that a total of the weights related to the dependence relationships between the entities within a same cluster will be higher than an expected value of the total; and
selecting, by the computer and when a count of entities within a cluster among the divided plurality of clusters exceeds a pre-stored upper-limit number of entities, an entity set within the cluster as the target entity set.
